(19) United States
(12) Patent Application Publication
(10) Pub. No.: US 2025/0202077 A1
(43) Pub. Date: Jun. 19, 2025

(54) BATTERY

(71) Applicant: Panasonic Intellectual Property Management Co., Ltd., Osaka (JP)

(72) Inventors: Kazuyoshi HONDA, Osaka (JP); Koichi HIRANO, Osaka (JP); Eiichi KOGA, Hokkaido (JP); Kazuhiro MORIOKA, Osaka (JP); Tsutomu KOSHIZUKA, Osaka (JP); Akira KAWASE, Osaka (JP)

(21) Appl. No.: 19/065,594

(22) Filed: Feb. 27, 2025

Related U.S. Application Data
(63) Continuation of application No. PCT/JP2023/028215, filed on Aug. 2, 2023.

(30) Foreign Application Priority Data
Sep. 21, 2022 (JP) 2022-150681

(51) Int. Cl. H01M 50/54; H01M 10/0585; H01M 50/186; H01M 50/46; H01M 50/474; H01M 50/486; H01M 50/548

(52) U.S. Cl. CPC H01M 50/54; H01M 10/0585; H01M 50/186; H01M 50/46; H01M 50/474; H01M 50/486; H01M 50/548

(57) ABSTRACT

A battery includes: a power generating element in which battery cells and current collectors are stacked, each of the battery cells including an electrode layer, a counter electrode layer, and a solid electrolyte layer; an electrode conductive connection portion; and a counter electrode insulating layer. The current collectors include an electrode current collector electrically connected to the electrode layer of a battery cell among the battery cells and a counter electrode current collector electrically connected to the counter electrode layer of a battery cell among the battery cells. The electrode conductive connection portion is connected to the electrode current collector on the side surface of the power generating element. The counter electrode insulating layer covers, on the side surface, a portion of the electrode conductive connection portion and at least a portion of the counter electrode current collector.

### CROSS REFERENCE TO RELATED APPLICATIONS

This is a continuation application of PCT International Application No. PCT/JP2023/028215 filed on Aug. 2, 2023, designating the United States of America, which is based on and claims priority of Japanese Patent Application No. 2022-150681 filed on Sep. 21, 2022. The entire disclosures of the above-identified applications, including the specifications, drawings, and claims are incorporated herein by reference in their entirety.

### FIELD

The present disclosure relates to a battery and a manufacturing method thereof.

### BACKGROUND

Patent Literature (PTL) 1 discloses batteries in which a plurality of unit cells stacked and connected in series are connected in parallel at their end surfaces.

PTL 2 discloses batteries in which a plurality of unit cells stacked and connected in series are connected in parallel at their end surfaces by protruding current collectors.

### CITATION LIST

### Patent Literature

PTL 1: Japanese Unexamined Patent Application Publication No. 2013-120717
PTL 2: Japanese Unexamined Patent Application Publication No. 2008-198492

### SUMMARY

### Technical Problem

Further improvement in battery characteristics over conventional batteries is sought. In particular, battery characteristics such as energy density, reliability, or high current characteristics of the battery are important in practical use of the battery.

In view of this, the present disclosure provides a high-performance battery and a manufacturing method thereof.

### Solution to Problem

A battery according to one aspect of the present disclosure includes: a power generating element including a plurality of battery cells and a plurality of current collectors, the plurality of battery cells and the plurality of current collectors being stacked with at least a portion of the plurality of battery cells electrically connected in parallel, each of the plurality of battery cells including an electrode layer, a counter electrode layer, and a solid electrolyte layer positioned between the electrode layer and the counter electrode layer; an electrode conductive connection portion; and a counter electrode insulating layer. Each of the plurality of battery cells is sandwiched between two adjacent current collectors among the plurality of current collectors. The plurality of current collectors include an electrode current collector electrically connected to the electrode layer of a battery cell among the plurality of battery cells and a counter electrode current collector electrically connected to the counter electrode layer of a battery cell among the plurality of battery cells. The electrode conductive connection portion is connected to the electrode current collector in a first region of a side surface of the power generating element. In the first region, the counter electrode insulating layer covers a portion of the electrode conductive connection portion and at least a portion of the counter electrode current collector.

A battery manufacturing method according to one aspect of the present disclosure is a manufacturing method of a battery including a power generating element, the power generating element including a plurality of battery cells and a plurality of current collectors, the plurality of battery cells and the plurality of current collectors being stacked with at least a portion of the plurality of battery cells electrically connected in parallel, each of the plurality of battery cells including an electrode layer, a counter electrode layer, and a solid electrolyte layer positioned between the electrode layer and the counter electrode layer, each of the plurality of battery cells is sandwiched between two adjacent current collectors among the plurality of current collectors, the plurality of current collectors including an electrode current collector electrically connected to the electrode layer of a battery cell among the plurality of battery cells and a counter electrode current collector electrically connected to the counter electrode layer of a battery cell among the plurality of battery cells. The battery manufacturing method includes: forming an electrode conductive connection portion connected to the electrode current collector in a first region of a side surface of the power generating element; and forming a counter electrode insulating layer covering a portion of the electrode conductive connection portion and at least a portion of the counter electrode current collector in the first region.

### Advantageous Effects

According to the present disclosure, it is possible to provide a high-performance battery and a manufacturing method thereof.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a cross-sectional view of a battery according to Embodiment 1.

FIG. 2 is a plan view of a power generating element of a battery according to Embodiment 1 when viewed from the side.

FIG. 3 is another plan view of a power generating element of a battery according to Embodiment 1 when viewed from the side.

FIG. 4A is a side view of a battery according to Embodiment 1.

FIG. 4B is another side view of a battery according to Embodiment 1.

FIG. 5 is a plan view illustrating another example of a counter electrode insulating layer according to Embodiment 1.

FIG. 6 is a cross-sectional view of a battery according to Embodiment 2.

FIG. 7 is a side view of a battery according to Embodiment 2.

FIG. 8 is a cross-sectional view of a battery according to Embodiment 3.

FIG. 9 is a plan view of a power generating element of a battery according to Embodiment 3 when viewed from the side.

FIG. 10 is a side view of a battery according to Embodiment 3.

FIG. 11 is a cross-sectional view of a battery according to Embodiment 4.

FIG. 12 is another cross-sectional view of a battery according to Embodiment 4.

FIG. 13 is a plan view of a power generating element of a battery according to Embodiment 4 when viewed from the side.

FIG. 14 is another plan view of a power generating element of a battery according to Embodiment 4 when viewed from the side.

FIG. 15 is a side view of a battery according to Embodiment 4.

FIG. 16 is a cross-sectional view of a battery according to Embodiment 5.

FIG. 17 is a cross-sectional view of a battery according to Embodiment 6.

FIG. 18 is a flowchart illustrating a manufacturing method of a battery according to an embodiment of the present disclosure.

FIG. 19A is a cross-sectional view of one example of a unit cell according to an embodiment of the present disclosure.

FIG. 19B is a cross-sectional view of another example of a unit cell according to an embodiment of the present disclosure.

FIG. 19C is a cross-sectional view of another example of a unit cell according to an embodiment of the present disclosure.

### DESCRIPTION OF EMBODIMENTS

### Overview of Present Disclosure

Hereinafter, a plurality of examples of batteries according to the present disclosure will be given.

For example, a battery according to a first aspect of the present disclosure includes: a power generating element including a plurality of battery cells and a plurality of current collectors, the plurality of battery cells and the plurality of current collectors being stacked with at least a portion of the plurality of battery cells electrically connected in parallel, each of the plurality of battery cells including an electrode layer, a counter electrode layer, and a solid electrolyte layer positioned between the electrode layer and the counter electrode layer; an electrode conductive connection portion; and a counter electrode insulating layer. Each of the plurality of battery cells is sandwiched between two adjacent current collectors among the plurality of current collectors. The plurality of current collectors include an electrode current collector electrically connected to the electrode layer of a battery cell among the plurality of battery cells and a counter electrode current collector electrically connected to the counter electrode layer of a battery cell among the plurality of battery cells. The electrode conductive connection portion is connected to the electrode current collector in a first region of a side surface of the power generating element. In the first region, the counter electrode insulating layer covers a portion of the electrode conductive connection portion and at least a portion of the counter electrode current collector.

This makes it possible to realize a high-performance battery. For example, a battery with excellent energy density, reliability, and high current characteristics can be realized.

More specifically, a plurality of battery cells are stacked, forming a power generating element with enhanced energy density. An electrode conductive connection portion and a counter electrode insulating layer are provided on the side surface of the power generating element. The counter electrode insulating layer covers a portion of the electrode conductive connection portion, realizing a high-performance battery. The connection portion between the electrode current collector and the electrode conductive connection portion on the side surface of the power generating element being of high strength is important for the performance, such as the reliability, of the battery. By the counter electrode insulating layer covering and holding a portion of the electrode conductive connection portion connected to the electrode current collector on the side surface of the power generating element, the strength of the mechanical connection between the electrode current collector and the electrode conductive connection portion increases, and the connection between the electrode current collector and the electrode conductive connection portion can be maintained with low resistance and high reliability. It is therefore possible to inhibit voltage loss caused by connection resistance, even during charging and discharging at high currents. With this, high current characteristics can be enhanced while both inhibiting heat generation at the connection portion between the electrode current collector and the electrode conductive connection portion and inhibiting strength degradation of the connection portion due to thermal expansion and deformation.

For example, the battery according to a second aspect of the present disclosure is the battery according to the first aspect, further including an electrode conductive extraction layer covering at least a portion of the counter electrode insulating layer in the first region and electrically connected to the electrode conductive connection portion.

This electrically connects the electrode conductive extraction layer, which covers the counter electrode insulating layer, to the electrode conductive connection portion, a portion of which is covered and held by the counter electrode insulating layer. It is therefore possible to realize the extraction electrode for the electrode layer of the battery via the electrode conductive extraction layer, while inhibiting short-circuiting.

For example, the battery according to a third aspect of the present disclosure is the battery according to the second aspect, wherein the electrode conductive connection portion includes a plurality of electrode conductive connection portions, in the first region, the plurality of electrode conductive connection portions are respectively connected to different electrode current collectors each of which is the electrode current collector, and the electrode conductive extraction layer is electrically connected to each of the plurality of electrode conductive connection portions in the first region.

With this, it is possible to realize the extraction electrode for the electrode layer of the entire battery via the electrode conductive extraction layer.

For example, the battery according to a fourth aspect of the present disclosure is the battery according to the third aspect, wherein the plurality of electrode conductive connection portions have a stripe shape in a plan view of the first region.

This allows for efficient connection of the plurality of stripe-shaped electrode conductive connection portions to the electrode current collector stacked on a battery cell in the first region.

For example, the battery according to a fifth aspect of the present disclosure is the battery according to the third or fourth aspect, wherein the electrode conductive extraction layer includes a plurality of electrode conductive extraction layers, and in a plan view of the first region, the plurality of electrode conductive extraction layers are aligned in a direction perpendicular to a stacking direction of the power generating element.

With this, it is possible to reduce the internal stress of the electrode conductive extraction layer in the side surface portion of the battery. This also makes it possible to disperse the impact when an external force is applied to the side surface portion of the battery.

For example, the battery according to a sixth aspect of the present disclosure is the battery according to any one of the second to fifth aspects, further including: a void surrounded by an inner wall formed by at least one selected from the group consisting of the first region, the electrode conductive connection portion, the counter electrode insulating layer, and the electrode conductive extraction layer.

Such a void makes it possible to alleviate internal stress due to expansion and contraction of the battery and mechanical shock.

For example, the battery according to a seventh aspect of the present disclosure is the battery according to any one of the first to sixth aspects, wherein the electrode conductive connection portion includes a first inclined surface so inclined with respect to the first region that a length in a stacking direction of the electrode conductive connection portion decreases with increasing distance from the first region of the power generating element, and the counter electrode insulating layer covers the first inclined surface.

With this, the counter electrode insulating layer covers the electrode conductive connection portion as if pressing toward the center of the electrode conductive connection portion, making it easier for force to be applied to the connection portion between the electrode conductive connection portion and the electrode current collector, thereby enabling the connection between the electrode conductive connection portion and the electrode current collector to be made more robust.

For example, the battery according to an eighth aspect of the present disclosure is the battery according to any one of the first to seventh aspects, further including: a counter electrode conductive connection portion connected to the counter electrode current collector in a second region of the side surface of the power generating element different from the first region; and an electrode insulating layer covering a portion of the counter electrode conductive connection portion and at least a portion of the electrode current collector in the second region.

In this way, a counter electrode conductive connection portion and an electrode insulating layer are provided on the side surface of the power generating element, and the electrode insulating layer covers a portion of the counter electrode conductive connection portion, realizing an even higher-performance battery. For example, by the electrode insulating layer covering and holding a portion of the counter electrode conductive connection portion connected to the counter electrode current collector on the side surface of the power generating element, the strength of the mechanical connection between the counter electrode current collector and the counter electrode conductive connection portion increases, and the connection between the counter electrode current collector and the counter electrode conductive connection portion can be maintained with low resistance and high reliability. It is therefore possible to inhibit voltage loss caused by connection resistance, even during charging and discharging at high currents. With this, high current characteristics can be enhanced while both inhibiting heat generation at the connection portion between the counter electrode current collector and the counter electrode conductive connection portion and inhibiting strength degradation of the connection portion due to thermal expansion and deformation.

For example, the battery according to a ninth aspect of the present disclosure is the battery according to the eighth aspect, further including: a counter electrode conductive extraction layer covering at least a portion of the electrode insulating layer in the second region and electrically connected to the counter electrode conductive connection portion.

This electrically connects the counter electrode conductive extraction layer, which covers the electrode insulating layer, to the counter electrode conductive connection portion, a portion of which is covered and held by the electrode insulating layer. It is therefore possible to realize the extraction electrode for the counter electrode layer of the battery via the counter electrode conductive extraction layer, while inhibiting short-circuiting.

For example, the battery according to a tenth aspect of the present disclosure is the battery according to the ninth aspect, wherein the counter electrode conductive extraction layer includes a plurality of counter electrode conductive extraction layers, and in a plan view of the first region, the plurality of counter electrode conductive extraction layers are aligned in a direction perpendicular to a stacking direction of the power generating element.

With this, it is possible to reduce the internal stress of the counter electrode conductive extraction layer in the side surface portion of the battery. This also makes it possible to disperse the impact when an external force is applied to the side surface portion of the battery.

For example, the battery according to an eleventh aspect of the present disclosure is the battery according to the ninth or tenth aspect, further including: an electrode conductive extraction layer covering at least a portion of the counter electrode insulating layer in the first region and electrically connected to the electrode conductive connection portion; an electrode current collecting terminal provided on one main surface of the power generating element and electrically connected to the electrode conductive extraction layer; and a counter electrode current collecting terminal provided on an other main surface of the power generating element and electrically connected to the counter electrode conductive extraction layer.

Since two current collector terminals with different polarities used for external connection and the like are arranged apart from each other, the occurrence of a short circuit can be inhibited.

For example, the battery according to a twelfth aspect of the present disclosure is the battery according to the ninth or tenth aspect, further including: an electrode conductive extraction layer covering at least a portion of the counter electrode insulating layer in the first region and electrically connected to the electrode conductive connection portion; an electrode current collecting terminal provided on one main surface of the power generating element and electrically connected to the electrode conductive extraction layer; and a counter electrode current collecting terminal provided on the one main surface and electrically connected to the counter electrode conductive extraction layer.

This makes the battery easier to mount since two current collector terminals with different polarities used for external connection and the like are provided on the same main surface. For example, the shape and arrangement of the current collector terminals can be adjusted according to the wiring layout of the mounting substrate, so the degree of freedom regarding connection with the mounting substrate can also be enhanced.

For example, the battery according to a thirteenth aspect of the present disclosure is the battery according to the eleventh or twelfth aspect, further including: a sealing component that exposes a portion of the electrode current collecting terminal and a portion of the counter electrode current collecting terminal, and seals the power generating element, the electrode conductive connection portion, the electrode conductive extraction layer, the counter electrode conductive connection portion, and the counter electrode conductive extraction layer.

With this, the power generating element can be protected against outside air and water, for example, and thus it is possible to further enhance the reliability of the battery.

For example, the battery according to a fourteenth aspect of the present disclosure is the battery according to any one of the eighth to thirteenth aspects, wherein the counter electrode conductive connection portion includes a second inclined surface so inclined with respect to the second region that a length in a stacking direction of the counter electrode conductive connection portion decreases with increasing distance from the second region of the power generating element, and the electrode insulating layer covers the second inclined surface.

With this, the electrode insulating layer covers the counter electrode conductive connection portion as if pressing toward the center of the counter electrode conductive connection portion, making it easier for force to be applied to the connection portion between the counter electrode conductive connection portion and the counter electrode current collector, thereby enabling the connection between the counter electrode conductive connection portion and the counter electrode current collector to be made more robust.

For example, the battery according to a fifteenth aspect of the present disclosure is the battery according to any one of the eighth to fourteenth aspects, wherein the first region and the second region are positioned on a same plane on the side surface of the power generating element.

With this, since both the electrode conductive connection portion and the counter electrode conductive connection portion are formed on the same plane, the manufacturing process for the electrode conductive connection portion and the counter electrode conductive connection portion can be simplified.

For example, the battery according to a sixteenth aspect of the present disclosure is the battery according to any one of the eighth to fifteenth aspects, wherein the electrode conductive connection portion is connected to the electrode current collector in the first region and the second region, and the counter electrode conductive connection portion is connected to the counter electrode current collector in the first region and the second region.

With this, the connection area between the electrode conductive connection portion and the electrode current collector, and the connection area between the counter electrode conductive connection portion and the counter electrode current collector can be increased without increasing the size of the electrode extraction structure in the battery.

For example, the battery according to a seventeenth aspect of the present disclosure is the battery according to any one of the first to sixteenth aspects, wherein the counter electrode insulating layer includes resin.

With this, it is possible to enhance the impact resistance of the battery. Moreover, it is possible to ease the stress exerted on the battery due to a temperature change of the battery or expansion and contraction of the battery when charging and discharging.

For example, the battery according to an eighteenth aspect of the present disclosure is the battery according to any one of the first to seventeenth aspects, wherein the electrode conductive connection portion is in a form of a broken line in a plan view of the first region.

With this, it is possible to reduce the internal stress of the electrode conductive connection portion in the side surface portion of the battery.

Hereinafter, a plurality of examples of manufacturing methods for batteries according to the present disclosure will be given.

For example, a battery manufacturing method according to a nineteenth aspect of the present disclosure is a manufacturing method of a battery including a power generating element, the power generating element including a plurality of battery cells and a plurality of current collectors, the plurality of battery cells and the plurality of current collectors being stacked with at least a portion of the plurality of battery cells electrically connected in parallel, each of the plurality of battery cells including an electrode layer, a counter electrode layer, and a solid electrolyte layer positioned between the electrode layer and the counter electrode layer, each of the plurality of battery cells is sandwiched between two adjacent current collectors among the plurality of current collectors, the plurality of current collectors including an electrode current collector electrically connected to the electrode layer of a battery cell among the plurality of battery cells and a counter electrode current collector electrically connected to the counter electrode layer of a battery cell among the plurality of battery cells. The battery manufacturing method includes: forming an electrode conductive connection portion connected to the electrode current collector in a first region of a side surface of the power generating element; and forming a counter electrode insulating layer covering a portion of the electrode conductive connection portion and at least a portion of the counter electrode current collector in the first region.

For example, a battery manufacturing method according to a twentieth aspect of the present disclosure is the battery manufacturing method according to the nineteenth aspect, wherein the forming of the electrode conductive connection portion includes forming the electrode conductive connection portion in plurality, each of which is connected, in the first region, to different electrode current collectors each of which is the electrode current collector, and the battery manufacturing method further includes forming an electrode conductive extraction layer covering at least a portion of the counter electrode insulating layer in the first region and electrically connected to each of the plurality of electrode conductive connection portions.

This electrically connects the electrode conductive extraction layer, which covers the counter electrode insulating layer, to the electrode conductive connection portion, a portion of which is covered and held by the counter electrode insulating layer, making it possible to realize the extraction electrode for the electrode layer of the battery.

A battery manufacturing method according to a twenty-first aspect of the present disclosure is the battery manufacturing method according to the nineteenth or twentieth aspect, further including: forming a counter electrode conductive connection portion connected to the counter electrode current collector in a second region of the side surface of the power generating element different from the first region; and forming an electrode insulating layer covering a portion of the counter electrode conductive connection portion and at least a portion of the electrode current collector in the second region.

For example, a battery manufacturing method according to a twenty-second aspect of the present disclosure is the battery manufacturing method according to the twenty-first aspect, further including: forming a counter electrode conductive extraction layer covering at least a portion of the electrode insulating layer in the second region and electrically connected to the counter electrode conductive connection portion.

These make it possible to manufacture the above-described high-performance battery.

Hereinafter, embodiments of the present disclosure will be described with reference to the drawings.

The embodiments described below each illustrate a general or a specific example. The numerical values, shapes, materials, elements, the arrangement and connection of the elements, steps, order of the steps, etc., shown in the following embodiments are mere examples, and therefore do not limit the scope of the present disclosure. Among the elements in the following exemplary embodiments, elements not recited in any one of the independent claims are described as optional elements.

The figures are schematic illustrations and are not necessarily precise depictions. Accordingly, the figures are not necessarily to scale. In the figures, the same reference signs are used for elements that are essentially the same. Accordingly, duplicate description is omitted or simplified.

In the present specification, terms indicating relationships between elements, such as “parallel”, terms indicating shapes of elements, such as “rectangular”, and numerical ranges are expressions that include, in addition to their exact meanings, substantially equivalent ranges, including differences of approximately a few percent, for example.

In the present specification and in the drawings, the x-, y-, and z-axes refer to the three axes of a three-dimensional Cartesian coordinate system. When the power generating element of the battery has a rectangular plan view shape, the x-axis is parallel to a first side of the rectangle and the y-axis is parallel to a second side of the rectangle that is orthogonal to the first side. The z-axis corresponds to the stacking direction of the plurality of battery cells included in the power generating element.

In the present specification, the “stacking direction” of the power generating element corresponds to the direction normal to the main surfaces of the current collectors and the layers of the battery cell. In the present specification, unless otherwise specified, “plan view” means a view in a direction perpendicular to the main surface. Note that when a “plan view of a certain surface (or a certain region)” is described, such as a “plan view of a side surface”, this refers to a view looking at the “certain surface (or certain region)” from the front.

In the present specification, the terms “upward” and “downward” do not refer to the upward (vertically upward) and downward (vertically downward) directions in absolute spatial perception, but are used as terms defined by relative positions based on the stacking order in the stacked configuration. The terms “above” and “below” apply not only when two elements are arranged spaced apart from each other and another element is present between the two elements, but also when two elements are arranged in close contact with each other such that the two elements touch. In the following description, the negative direction of the z-axis corresponds to the direction referred to by terms like “down” or “lower” and the positive direction of the z-axis corresponds to the direction referred to by terms like “up” or “upper”.

In the present specification, unless otherwise specified, the expression “covering A” means covering at least a part of A. Stated differently, “covering A” is an expression that includes not only cases in which all of A is covered, but also cases in which only a portion of A is covered. Examples of “A” include a predetermined component such as a layer or terminal, as well as a side or main surface of the predetermined component.

In the present specification, unless otherwise specified, ordinal numerals such as “first” and “second” do not refer to the number or order of elements, but are used to avoid confusion and to distinguish between like elements.

### Embodiment 1

First, the configuration of the battery according to Embodiment 1 will be described.

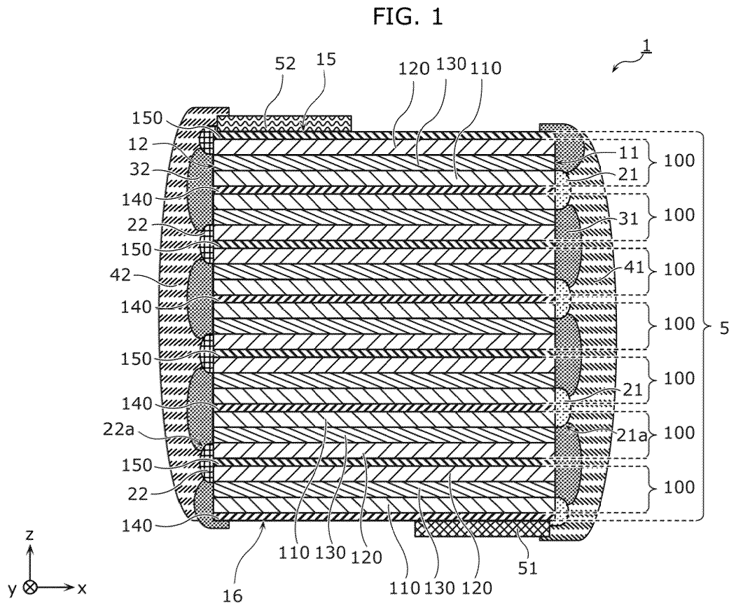

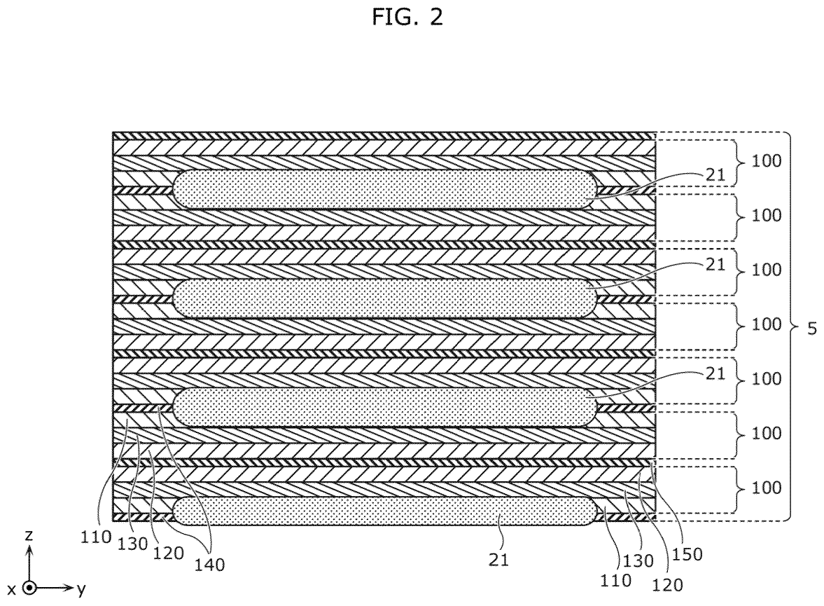

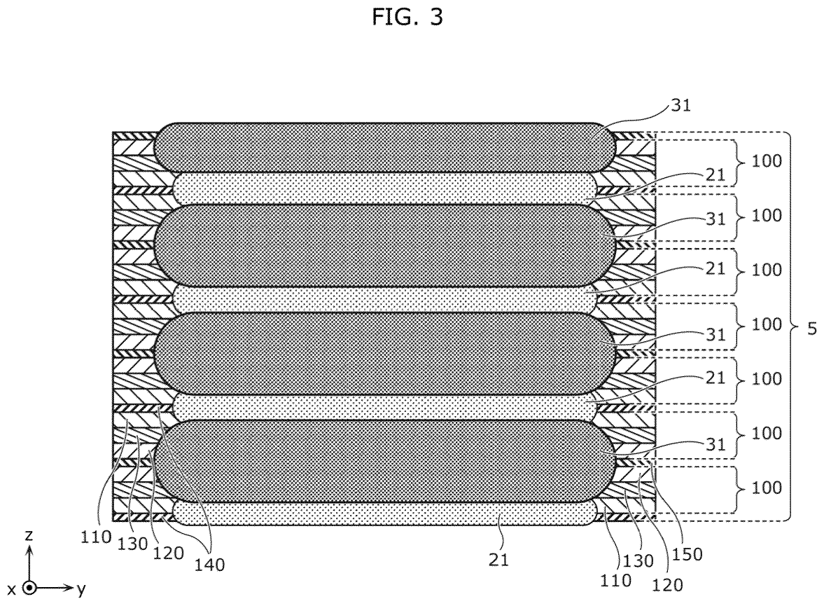

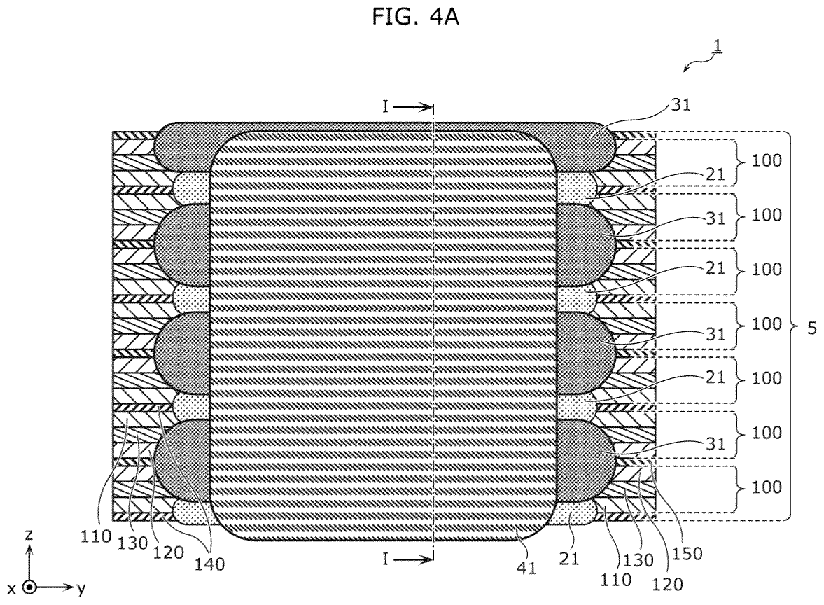

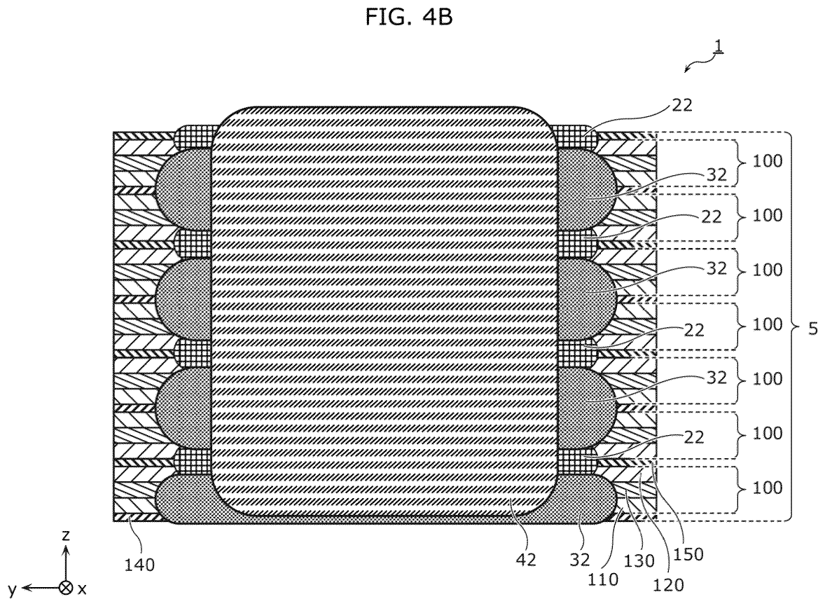

FIG. 1 is a cross-sectional view of battery 1 according to the present embodiment. FIG. 2 is a plan view of power generating element 5 of battery 1 according to the present embodiment when viewed from the side (positive x-axis direction). FIG. 3 is another plan view of power generating element 5 of battery 1 according to the present embodiment when viewed from the side (positive x-axis direction). FIG. 4A is a side view of battery 1 according to the present embodiment. FIG. 4B is another side view of battery 1 according to the present embodiment. More specifically, FIG. 1 illustrates a cross section taken along line I-I illustrated in FIG. 4A. FIG. 2 and FIG. 3 illustrate intermediate states in the manufacturing of battery 1. FIG. 2 is a view of battery 1 with counter electrode insulating layer 31 and electrode conductive extraction layer 41 removed. FIG. 3 is a view of battery 1 with electrode conductive extraction layer 41 removed. Battery 1 is manufactured, for example, by going through the states illustrated in FIG. 2 and FIG. 3 in this order. FIG. 4A is a plan view of battery 1 when viewed from the positive x-axis direction. FIG. 4B is a plan view of battery 1 when viewed from the negative x-axis direction.

As illustrated in FIG. 1, battery 1 includes power generating element 5, electrode conductive connection portion 21, counter electrode conductive connection portion 22, counter electrode insulating layer 31, electrode insulating layer 32, electrode conductive extraction layer 41, counter electrode conductive extraction layer 42, electrode current collecting terminal 51, and counter electrode current collecting terminal 52. Battery 1 is, for example, an all-solid-state battery.

### Power Generating Element

First, the specific configuration of power generating element 5 will be described.

Power generating element 5 has a structure in which a plurality of battery cells 100 and a plurality of current collectors are stacked in the thickness direction of the plurality of battery cells 100. Such a stacked structure enables an increase in the energy density of battery 1.

The plan view shape of power generating element 5 is, for example, rectangular. Stated differently, the general shape of power generating element 5 is a flat rectangular parallelepiped. Here, “flat” means that the thickness (i.e., the length in the z-axis direction) is shorter than each side of the main surface (i.e., the length in each of the x-axis direction and the y-axis directions) or the maximum width. The plan view shape of power generating element 5 may be some other polygonal shape such as square, hexagonal, or octagonal, and, alternatively, may be circular or elliptical. The outer edge of power generating element 5 in plan view may be uneven. In the drawings accompanying the present specification, the thickness of each layer is exaggerated in the cross-sectional views such as FIG. 1 and in plan views from the side such as FIG. 2 through FIG. 4B in order to more clearly convey the layered structure of power generating element 5.

Power generating element 5 includes a side surface, main surface 15, and main surface 16. The side surface of power generating element 5 is a surface that connects main surface 15 and main surface 16. In the present embodiment, the general shape of power generating element 5 is a rectangular parallelepiped, and the side surface of power generating element 5 includes, as individual surfaces, four side surfaces including side surface 11 and side surface 12. In the present embodiment, each of the four side surfaces of power generating element 5, main surface 15, and main surface 16 is a flat surface. Accordingly, the entire battery cell 100 or a portion thereof not protruding at the end portion of power generating element 5 improves the mechanical strength of the end portion of power generating element 5. Side surface 11 is one example of the first region of the side surface of power generating element 5. Side surface 12 is one example of the second region of the side surface of power generating element 5. Depending on the shape of power generating element 5, the side surface of power generating element 5 may be a curved surface or a combination of a flat surface and a curved surface.

Side surfaces 11 and 12 face away from each other, and are parallel to each other. The two side surfaces of power generating element 5 other than side surfaces 11 and 12 also face away from each other, and are parallel to each other. The two other side surfaces are surfaces that are perpendicular to side surface 11 and side surface 12. The four side surfaces of power generating element 5 are erected vertically with respect to main surface 15 and main surface 16 from the edges of main surface 15 and main surface 16. The four side surfaces of power generating element 5 are each, for example, a cut surface. This allows the area of each layer of battery cell 100 to be accurately determined by cutting, thereby reducing capacity variation between batteries 1 and increasing battery capacity accuracy.

Main surface 15 and main surface 16 face away from each other, and are parallel to each other. Main surface 15 is the uppermost surface of power generating element 5. Main surface 16 is the lowermost surface of power generating element 5. Main surface 15 and main surface 16 each have, for example, an area larger than any of the four side surfaces of power generating element 5.

As illustrated in FIG. 1 through FIG. 4B, power generating element 5 includes a plurality of battery cells 100 and a plurality of current collectors. The plurality of current collectors include electrode current collector 140 electrically connected to electrode layer 110 and counter electrode current collector 150 electrically connected to counter electrode layer 120. In the present embodiment, each of the plurality of current collectors is either electrode current collector 140 or counter electrode current collector 150. Battery cell 100 is the smallest component of the power generating portion of the battery and is also referred to as a unit cell. Battery cell 100 and the current collector stacked on battery cell 100 may be collectively referred to as a unit cell. A plurality of battery cells 100 are stacked so as to be electrically connected in parallel. In the present embodiment, all battery cells 100 included in power generating element 5 are stacked so as to be electrically connected in parallel. Accordingly, since no series connection of battery cells 100 exists inside power generating element 5, unevenness in the charge and discharge state caused by the capacity difference of battery cells 100 is unlikely to occur during charging and discharging. Therefore, in power generating element 5, the risk of some battery cells 100 becoming overcharged or over-discharged can be considerably reduced.

In the illustrated example, power generating element 5 includes seven battery cells 100. However, power generating element 5 is not limited to this example. For example, power generating element 5 may include an even number of battery cells 100, such as two or four, or an odd number, such as three or five.

Each of battery cells 100 includes electrode layer 110, counter electrode layer 120, and solid electrolyte layer 130. Electrode layer 110 and counter electrode layer 120 each include an active material and are also referred to as the electrode active material layer and the counter electrode active material layer, respectively. In each of the plurality of battery cells 100, electrode layer 110, solid electrolyte layer 130, and counter electrode layer 120 are stacked along the z-axis in the listed order.

Electrode layer 110 is one of the cathode layer or the anode layer of battery cell 100. Counter electrode layer 120 is the other of the cathode layer or the anode layer of battery cell 100. In the following, as one example, electrode layer 110 is described as the anode layer and counter electrode layer 120 is described as the cathode layer.

Each of the plurality of battery cells 100 of power generating element 5 is sandwiched between two adjacent current collectors among the plurality of current collectors (specifically, one electrode current collector 140 and one counter electrode current collector 150). Two adjacent battery cells 100 are stacked with one of the plurality of current collectors interposed therebetween.

The configuration of each battery cell 100 is substantially the same. In two adjacent battery cells 100, the order in which the layers of battery cell 100 are stacked is reversed. Stated differently, the plurality of battery cells 100 are stacked along the z-axis, and the order in which the layers of battery cell 100 are layered alternate. Therefore, in two adjacent battery cells 100, electrode layers 110 or counter electrode layers 120 are arranged facing each other. Electrode current collector 140 is arranged between the facing electrode layers 110, and counter electrode current collector 150 is arranged between the facing counter electrode layers 120. Electrode current collector 140 is stacked on electrode layer 110 without solid electrolyte layer 130 interposed therebetween, and counter electrode current collector 150 is stacked on counter electrode layer 120 without solid electrolyte layer 130 interposed therebetween. As a result, electrode current collector 140 and counter electrode current collector 150 are arranged alternately one by one along the z-axis direction.

With this configuration, a plurality of battery cells 100 are stacked so as to be electrically connected in parallel. In this way, battery 1 is a parallel-connected stacked battery in which a plurality of battery cells 100 and a plurality of current collectors are stacked and integrated. In the present embodiment, since the number of battery cells 100 is odd, the bottom-most portion and top-most portion in power generating element 5 are a layer and a current collector of opposite polarity, respectively. At least one of the bottom-most portion and top-most portion of power generating element 5 includes, for example, electrode layer 110 and electrode current collector 140. Note that when the number of battery cells 100 is even, the bottom-most portion and top-most portion in power generating element 5 are a layer and a current collector of the same polarity, respectively.

In the present embodiment, since three or more battery cells 100 are stacked, the plurality of current collectors include a plurality of electrode current collectors 140 and a plurality of counter electrode current collectors 150. Note that when only two battery cells 100 are stacked, one of electrode current collector 140 or counter electrode current collector 150 becomes singular, for example, counter electrode current collector 150 becomes singular. In this case, counter electrode conductive connection portion 22 connected to counter electrode current collector 150 in side surface 12 also becomes singular.

The plurality of electrode current collectors 140 and the plurality of counter electrode current collectors 150 are each exposed on the side surface of power generating element 5, not covered by battery cells 100. Electrode current collectors 140 are not in direct contact with each other, but rather are electrically connected via electrode conductive connection portion 21 and electrode conductive extraction layer 41 in order to connect battery cells 100 in parallel. Counter electrode current collectors 150 are not in direct contact with each other, but rather are electrically connected via counter electrode conductive connection portion 22 and counter electrode conductive extraction layer 42 in order to connect battery cells 100 in parallel. Since there is no need to extend the end portions of the current collectors of power generating elements 5, the size of the connection structure can be reduced compared to when the end portions of the current collectors are bundled together to form a parallel connection.

Electrode current collector 140 and counter electrode current collector 150 are each a conductive foil, plate, or mesh-like component. Electrode current collector 140 and counter electrode current collector 150 may each be, for example, a conductive thin film. In the example illustrated in FIG. 1, electrode current collector 140 and counter electrode current collector 150 are each a single metal foil. Electrode current collector 140 and counter electrode current collector 150 may each have a multilayer structure including a plurality of current collecting layers of a plurality of metal foils or the like. In such cases, a plurality of current collecting layers are stacked either directly or with intermediate layers therebetween.

For example, metals such as stainless steel (SUS), aluminum (Al), copper (Cu), and nickel (Ni) can be used for electrode current collector 140 and counter electrode current collector 150. Electrode current collector 140 and counter electrode current collector 150 may be formed using different materials.

The thickness of electrode current collector 140 and counter electrode current collector 150 is, for example, but not limited to, between 5 μm and 200 μm, inclusive.

Electrode layer 110 is in contact with the main surface of electrode current collector 140. The two main surfaces of electrode current collectors 140 sandwiched between two battery cells 100 are in contact with electrode layers 110. Only one of the two main surfaces (specifically, the upper surface) of the lowermost electrode current collector 140 is in contact with electrode layer 110. Electrode current collector 140 may include a connection layer, which is a layer including a conductive material, provided at the portion in contact with electrode layer 110.

Counter electrode layer 120 is in contact with the main surface of counter electrode current collector 150. The two main surfaces of counter electrode current collectors 150 sandwiched between two battery cells 100 are in contact with counter electrode layers 120. Only one of the two main surfaces (specifically, the lower surface) of uppermost counter electrode current collector 150 is in contact with counter electrode layer 120. Counter electrode current collector 150 may include a connection layer, which is a layer including a conductive material, provided at the portion in contact with counter electrode layer 120.

Electrode layer 110 is arranged on a main surface of electrode current collector 140. Electrode layer 110 includes, for example, an anode active material as the electrode material. Electrode layer 110 is arranged opposing counter electrode layer 120.

Anode active materials such as graphite and metallic lithium, for example, can be used as the anode active material included in electrode layer 110. Various materials that can release and insert ions, such as lithium (Li) or magnesium (Mg), can be used as the anode active material.

A solid electrolyte, such as an inorganic solid electrolyte, for example, may be further used as a material included in electrode layer 110. For example, a sulfide solid electrolyte or an oxide solid electrolyte can be used as the inorganic solid electrolyte. For example, a mixture of lithium sulfide (Li₂S) and diphosphorus pentasulfide (P₂S₅) can be used as the sulfide solid electrolyte. A conducting agent, such as acetylene black, or a binder, such as polyvinylidene fluoride, for example, may be further used as a material included in electrode layer 110.

Electrode layer 110 is made by coating a paste-like paint, in which the materials to be included in electrode layer 110 are kneaded together with a solvent, onto a main surface of electrode current collector 140 and allowing it to dry, for example. To increase the density of electrode layer 110, electrode current collector 140 coated with electrode layer 110 (also called an electrode plate) may be pressed after drying. The thickness of electrode layer 110 is, for example, but not limited to, between 5 μm and 300 μm, inclusive.

Counter electrode layer 120 is arranged on a main surface of counter electrode current collector 150. Counter electrode layer 120 is a layer including a cathode material such as an active material, for example. The cathode material is the material that constitutes a counter electrode to the anode material. Counter electrode layer 120 includes, for example, a cathode active material.

Examples of the cathode active material included in counter electrode layer 120 include, for example, lithium cobalt oxide (LCO), lithium nickel oxide (LNO), lithium manganese oxide (LMO), lithium-manganese-nickel oxide (LMNO), lithium-manganese-cobalt oxide (LMCO), lithium-nickel-cobalt oxide (LNCO), and lithium-nickel-manganese-cobalt oxide (LNMCO). Various materials that can release and insert ions, such as Li or Mg, can be used as the cathode active material.

A solid electrolyte, such as an inorganic solid electrolyte, for example, may be further used as a material included in counter electrode layer 120. A sulfide solid electrolyte or an oxide solid electrolyte can be used as the inorganic solid electrolyte. For example, a mixture of Li₂S and P₂S₅ can be used as the sulfide solid electrolyte. The surface of the cathode active material may be coated with a solid electrolyte. A conducting agent, such as acetylene black, or a binder, such as polyvinylidene fluoride, for example, may be further used as a material included in counter electrode layer 120.

Counter electrode layer 120 is made by coating a paste-like paint, in which the materials to be included in counter electrode layer 120 are kneaded together with a solvent, onto a main surface of counter electrode current collector 150 and allowing it to dry, for example. To increase the density of counter electrode layer 120, counter electrode current collector 150 coated with counter electrode layer 120 (also called a counter electrode plate) may be pressed after drying. The thickness of counter electrode layer 120 is, for example, but not limited to, between 5 μm and 300 μm, inclusive.

Solid electrolyte layer 130 is arranged between electrode layer 110 and counter electrode layer 120. Solid electrolyte layer 130 contacts each of electrode layer 110 and counter electrode layer 120. Solid electrolyte layer 130 has, for example, lithium ion conductivity. Solid electrolyte layer 130 is a layer including an electrolyte material. The electrolyte material may be a generally known electrolyte used for batteries. The thickness of solid electrolyte layer 130 may be between 5 μm and 300 μm, inclusive, or between 5 μm and 100 μm, inclusive.

Solid electrolyte layer 130 includes a solid electrolyte. For example, a solid electrolyte such as an inorganic solid electrolyte can be used as the solid electrolyte. A sulfide solid electrolyte or an oxide solid electrolyte can be used as the inorganic solid electrolyte. For example, a mixture of Li₂S and P₂S₅ can be used as the sulfide solid electrolyte. In addition to the electrolyte material, solid electrolyte layer 130 may include a binder such as polyvinylidene fluoride, for example.

In the present embodiment, electrode layer 110, counter electrode layer 120, and solid electrolyte layer 130 are maintained as parallel plates. This inhibits the occurrence of cracking or collapse due to curvature. Electrode layer 110, counter electrode layer 120, and solid electrolyte layer 130 may be smoothly curved together.

In battery cell 100, for example, the shape and size of each of electrode layer 110, solid electrolyte layer 130, and counter electrode layer 120 are the same in plan view, and their respective contours match. The size of each battery cell 100 is substantially the same. For example, in plan view, the shape and size of each of the plurality of battery cells 100, the plurality of electrode current collectors 140, and the plurality of counter electrode current collectors 150 are the same, and their respective contours match.

### Conductive Connection Portion, Insulating Layer, and Conductive Extraction Layer

Next, electrode conductive connection portion 21, counter electrode conductive connection portion 22, counter electrode insulating layer 31, electrode insulating layer 32, electrode conductive extraction layer 41, and counter electrode conductive extraction layer 42 will be described with reference to FIG. 1 through FIG. 4B. FIG. 2, FIG. 3, and FIG. 4A are each a plan view of side surface 11 of power generating element 5. FIG. 4B is a plan view of side surface 12 of power generating element 5. In FIG. 2 through FIG. 4B, each component illustrated in the plan view is shaded with the same shading used for each component illustrated in the cross section of FIG. 1. This is also true for the plan views described below.

Battery 1 includes a plurality of electrode conductive connection portions 21 and a plurality of counter electrode conductive connection portions 22.

As illustrated in FIG. 1, FIG. 2, FIG. 3, and FIG. 4A, each of the plurality of electrode conductive connection portions 21 is a conductive component connected to different electrode current collector 140 in side surface 11. In the plan view of side surface 11, each of the plurality of electrode conductive connection portions 21 extends in a direction perpendicular to the stacking direction of power generating element 5, and is in the form of an elongated, continuous solid line. In the plan view of side surface 11, the direction perpendicular to the stacking direction of power generating element 5 is also the extending direction of each layer and each current collector of power generating element 5.

Each of the plurality of electrode conductive connection portions 21 covers a different electrode current collector 140 on side surface 11. The plurality of electrode conductive connection portions 21 are respectively connected in contact with and cover the plurality of electrode current collectors 140 of power generating element 5 in side surface 11. Electrode conductive connection portion 21 and electrode current collector 140 are connected in a one-to-one correspondence relationship on side surface 11. Stated differently, each electrode conductive connection portion 21 is not connected to two or more electrode current collectors 140 on side surface 11. In the plan view of side surface 11, the plurality of electrode conductive connection portions 21 respectively overlap the plurality of electrode current collectors 140 and extend along the plurality of electrode current collectors 140. The plurality of electrode conductive connection portions 21 are connected in contact with and cover electrode layers 110 of the plurality of battery cells 100 in side surface 11. Electrode conductive connection portion 21 does not cover the plurality of counter electrode current collectors 150 of power generating element 5, and does not cover counter electrode layer 120 of each of the plurality of battery cells 100. Accordingly, in the plan view of side surface 11, the plurality of electrode conductive connection portions 21 are formed in a stripe shape. In the plan view of side surface 11, the plurality of electrode conductive connection portions 21 are aligned in the stacking direction of power generating element 5.

Electrode conductive connection portion 21 continuously covers electrode layers 110 of two adjacent battery cells 100. More specifically, electrode conductive connection portion 21 continuously covers a region from at least a portion of electrode layer 110 of one of two adjacent battery cells 100, through electrode current collector 140, to at least a portion of electrode layer 110 of the other of the two adjacent battery cells 100. Electrode conductive connection portion 21 may cover solid electrolyte layer 130. Electrode conductive connection portion 21 need not cover electrode layer 110.

Thus, because electrode conductive connection portion 21 is connected to electrode current collector 140 on side surface 11, the structure of the electrical connection with electrode current collector 140 on side surface 11 becomes robust. For example, by connecting electrode conductive extraction layer 41 via electrode conductive connection portion 21 rather than directly connecting to each of the plurality of electrode current collectors 140 in side surface 11, it becomes easier to bring electrode conductive connection portion 21 into contact with electrode current collector 140, and the strength of the connection can be enhanced.

In power generating element 5 according to the present embodiment, the bottom-most layer is electrode current collector 140. As illustrated in FIG. 1, in the vicinity of the bottom edge of side surface 11, electrode conductive connection portion 21 partially covers the main surface (i.e., main surface 16) of bottom-most electrode current collector 140.

Each of the plurality of electrode conductive connection portions 21 includes first inclined surface 21a so inclined with respect to side surface 11 that the length in the stacking direction of electrode conductive connection portion 21 decreases with increasing distance from side surface 11. First inclined surface 21a is the surface of electrode conductive connection portion 21 located on the side opposite to side surface 11. At least a portion of first inclined surface 21a is covered by counter electrode insulating layer 31. In the plurality of electrode conductive connection portions 21, the height from side surface 11 of the portion covered by counter electrode insulating layer 31 is lower than the height from side surface 11 of the portion not covered by counter electrode insulating layer 31 (in other words, the portion covered by electrode conductive extraction layer 41). The cross-sectional shape of electrode conductive connection portion 21 is, for example, convex in a dome shape or mountain shape in the direction away from side surface 11. Note that at least one of the plurality of electrode conductive connection portions 21 need not include first inclined surface 21a. In such cases, the cross-sectional shape of electrode conductive connection portion 21 may be, for example, rectangular.

As illustrated in FIG. 1 and FIG. 4B, each of the plurality of counter electrode conductive connection portions 22 is a conductive component connected to different counter electrode current collector 150 in side surface 12. In the plan view of side surface 12, each of the plurality of counter electrode conductive connection portions 22 extends in a direction perpendicular to the stacking direction of power generating element 5, and is in the form of an elongated, continuous solid line. In the plan view of side surface 12, the direction perpendicular to the stacking direction of power generating element 5 is also the extending direction of each layer and each current collector of power generating element 5.

Each of the plurality of counter electrode conductive connection portions 22 covers a different counter electrode current collector 150 on side surface 12. The plurality of counter electrode conductive connection portions 22 are respectively connected in contact with and cover the plurality of counter electrode current collectors 150 of power generating element 5 in side surface 12. Counter electrode conductive connection portion 22 and counter electrode current collector 150 are connected in a one-to-one correspondence relationship on side surface 12. Stated differently, each counter electrode conductive connection portion 22 is not connected to two or more counter electrode current collectors 150 on side surface 12. In the plan view of side surface 12, the plurality of counter electrode conductive connection portions 22 respectively overlap the plurality of counter electrode current collectors 150 and extend along the plurality of counter electrode current collectors 150. The plurality of counter electrode conductive connection portions 22 are connected in contact with and cover counter electrode layers 120 of the plurality of battery cells 100 in side surface 12. Counter electrode conductive connection portion 22 does not cover the plurality of electrode current collectors 140 of power generating element 5, and does not cover electrode layer 110 of each of the plurality of battery cells 100. Accordingly, in the plan view of side surface 12, the plurality of counter electrode conductive connection portions 22 are formed in a stripe shape. In the plan view of side surface 12, the plurality of counter electrode conductive connection portions 22 are aligned in the stacking direction of power generating element 5.

Counter electrode conductive connection portion 22 continuously covers counter electrode layers 120 of two adjacent battery cells 100. More specifically, counter electrode conductive connection portion 22 continuously covers a region from at least a portion of counter electrode layer 120 of one of two adjacent battery cells 100, through counter electrode current collector 150, to at least a portion of counter electrode layer 120 of the other of the two adjacent battery cells 100. Counter electrode conductive connection portion 22 may cover solid electrolyte layer 130. Counter electrode conductive connection portion 22 need not cover counter electrode layer 120.

Thus, because counter electrode conductive connection portion 22 is connected to counter electrode current collector 150 on side surface 12, the structure of the electrical connection with counter electrode current collector 150 on side surface 12 becomes robust. For example, by connecting counter electrode conductive extraction layer 42 via counter electrode conductive connection portion 22 rather than directly connecting to each of the plurality of counter electrode current collectors 150 in side surface 12, it becomes easier to bring counter electrode conductive connection portion 22 into contact with counter electrode current collector 150, and the strength of the connection can be enhanced.

In power generating element 5 according to the present embodiment, the top-most layer is counter electrode current collector 150. As illustrated in FIG. 1, in the vicinity of the top edge of side surface 12, counter electrode conductive connection portion 22 partially covers the main surface (i.e., main surface 15) of top-most counter electrode current collector 150.

Each of the plurality of counter electrode conductive connection portions 22 includes second inclined surface 22a so inclined with respect to side surface 12 that the length in the stacking direction of counter electrode conductive connection portion 22 decreases with increasing distance from side surface 12. Second inclined surface 22a is the surface of counter electrode conductive connection portion 22 located on the side opposite to side surface 12. At least a portion of second inclined surface 22a is covered by electrode insulating layer 32. In the plurality of counter electrode conductive connection portions 22, the height from side surface 12 of the portion covered by electrode insulating layer 32 is lower than the height from side surface 12 of the portion not covered by electrode insulating layer 32 (in other words, the portion covered by counter electrode conductive extraction layer 42). The cross-sectional shape of counter electrode conductive connection portion 22 is, for example, convex in a dome shape or mountain shape in the direction away from side surface 12. Note that at least one of the plurality of counter electrode conductive connection portions 22 need not include second inclined surface 22a. In such cases, the cross-sectional shape of counter electrode conductive connection portion 22 may be, for example, rectangular.

Electrode conductive connection portion 21 and counter electrode conductive connection portion 22 are each formed using a conductive resin material or the like. The conductive resin material includes, for example, a resin and a conductive material of metal particles or the like filled in the resin. Alternatively, electrode conductive connection portion 21 and counter electrode conductive connection portion 22 may each be formed using a metallic material such as solder. Available conductive materials are selected based on various properties such as flexibility, gas barrier, impact resistance, and heat resistance. Electrode conductive connection portion 21 and counter electrode conductive connection portion 22 are formed using the same material as each other, but may be formed using different materials.

Battery 1 includes a plurality of counter electrode insulating layers 31 and a plurality of electrode insulating layers 32. Note that the plurality of counter electrode insulating layers 31 may be connected to each other to form one or two or more counter electrode insulating layers 31. The plurality of electrode insulating layers 32 may be connected to each other to form one or two or more electrode insulating layers 32.

As illustrated in FIG. 1, FIG. 3, and FIG. 4A, each of the plurality of counter electrode insulating layers 31 covers at least a portion of a different counter electrode current collector 150 in side surface 11. In the plan view of side surface 11, each of the plurality of counter electrode insulating layers 31 is elongated and extends in a direction perpendicular to the stacking direction of power generating element 5.

In side surface 11, each of the plurality of counter electrode insulating layers 31 covers a portion of electrode conductive connection portion 21, specifically, an end portion of electrode conductive connection portion 21 in the stacking direction of power generating element 5. Electrode conductive connection portions 21 other than electrode conductive connection portion 21 in the bottom-most portion have both end portions in the stacking direction of power generating element 5 covered by counter electrode insulating layer 31.

Each of the plurality of counter electrode insulating layers 31 is in contact with first inclined surface 21a of electrode conductive connection portion 21 and covers first inclined surface 21a. With this, counter electrode insulating layer 31 covers electrode conductive connection portion 21 as if pressing toward the center of electrode conductive connection portion 21, making it easier for force to be applied to the connection portion between electrode conductive connection portion 21 and electrode current collector 140, thereby enabling the connection between electrode conductive connection portion 21 and electrode current collector 140 to be made more robust. For example, due to the elastic force of counter electrode insulating layer 31, a force is generated by which counter electrode insulating layer 31 presses against electrode conductive connection portion 21. When power generating element 5 expands or contracts, or when battery 1 is sealed or the like, counter electrode insulating layer 31 readily applies pressure to press down on electrode conductive connection portion 21. Note that the plurality of electrode conductive connection portions 21 may include those that are not covered by counter electrode insulating layer 31.

As illustrated in FIG. 1, each of the plurality of counter electrode insulating layers 31 is positioned between side surface 11 and electrode conductive extraction layer 41. In this way, by battery 1 including a plurality of counter electrode insulating layers 31, short-circuiting due to contact between counter electrode current collector 150 and electrode conductive extraction layer 41 can be inhibited.

As illustrated in FIG. 1, FIG. 3, and FIG. 4A, the plurality of counter electrode insulating layers 31 contact and cover the plurality of counter electrode current collectors 150 of power generating element 5 in side surface 11. In side surface 11, one counter electrode insulating layer 31 covers one counter electrode current collector 150. In the plan view of side surface 11, the plurality of counter electrode insulating layers 31 respectively overlap the plurality of counter electrode current collectors 150 and extend along the plurality of counter electrode current collectors 150. The plurality of counter electrode insulating layers 31 are in contact with and cover counter electrode layers 120 of the plurality of battery cells 100 in side surface 11. Counter electrode insulating layer 31 does not cover the plurality of electrode current collectors 140 of power generating element 5, and does not cover electrode layer 110 of each of the plurality of battery cells 100. Accordingly, in the plan view of side surface 11, the plurality of counter electrode insulating layers 31 are formed in a stripe shape. In the plan view of side surface 11, the plurality of counter electrode insulating layers 31 are aligned in the stacking direction of power generating element 5.

Counter electrode insulating layer 31 continuously covers counter electrode layers 120 of two adjacent battery cells 100. More specifically, counter electrode insulating layer 31 continuously covers a region from at least a portion of solid electrolyte layer 130 of one of two adjacent battery cells 100 to at least a portion of solid electrolyte layer 130 of the other of the two adjacent battery cells 100.

Thus, in side surface 11, counter electrode insulating layer 31 covers at least a portion of solid electrolyte layer 130. This reduces the risk of exposing counter electrode layer 120 even if the widths (lengths in the z-axis direction) of counter electrode insulating layers 31 differ due to manufacturing variations. This inhibits a short circuit between electrode layer 110 and counter electrode layer 120 via electrode conductive extraction layer 41, which is formed to cover counter electrode insulating layer 31. In addition, the end surface of solid electrolyte layer 130, which is formed of powdery material, has very fine irregularities. Counter electrode insulating layer 31 interlocks with these irregularities, which improves the adhesion strength of counter electrode insulating layer 31 and improves insulation reliability.

In the present embodiment, on side surface 11, the contour of counter electrode insulating layer 31 overlaps the boundary between solid electrolyte layer 130 and electrode layer 110. Counter electrode insulating layer 31 is not required to cover solid electrolyte layer 130 in side surface 11. For example, on side surface 11, the contour of counter electrode insulating layer 31 may overlap the boundary between solid electrolyte layer 130 and counter electrode layer 120. Counter electrode insulating layer 31 may cover a portion of electrode layer 110 in side surface 11.

In power generating element 5 according to the present embodiment, the top-most layer is counter electrode current collector 150. As illustrated in FIG. 1, in the vicinity of the top edge of side surface 11, counter electrode insulating layer 31 partially covers the main surface (i.e., main surface 15) of top-most counter electrode current collector 150. As a result, counter electrode insulating layer 31 is resistant to external forces, such as those from the z-axis direction, inhibiting detachment. Even if electrode conductive extraction layer 41 wraps around main surface 15 of power generating element 5, it can prevent a short circuit from occurring by contacting counter electrode current collector 150.

In this way, battery 1 includes electrode conductive connection portion 21 and counter electrode insulating layer 31, and in side surface 11, counter electrode insulating layer 31 covers a portion of electrode conductive connection portion 21. This allows the connection between the end portion of electrode current collector 140 and electrode conductive connection portion 21 to be firmly maintained.

More specifically, the connection portion between electrode current collector 140 and electrode conductive connection portion 21 on side surface 11 being robust is important for the performance, such as the reliability, of battery 1. However, since high conductivity performance is required for electrode conductive connection portion 21, there are cases where it is difficult to sufficiently enhance flexibility and adhesiveness. In view of this, by counter electrode insulating layer 31, which has a wider range of material selection than electrode conductive connection portion 21, covering and holding a portion of electrode conductive connection portion 21 connected to electrode current collector 140, the strength of the mechanical connection between electrode current collector 140 and electrode conductive connection portion 21 increases, and the connection between electrode current collector 140 and electrode conductive connection portion 21 can be maintained with low resistance and high reliability. Accordingly, it is possible to inhibit voltage loss caused by connection resistance, even during charging and discharging at high currents. With this, high current characteristics can be enhanced while both inhibiting heat generation at the connection portion between electrode current collector 140 and electrode conductive connection portion 21 and inhibiting strength degradation of the connection portion due to thermal expansion and deformation.

As illustrated in FIG. 1 and FIG. 4B, each of the plurality of electrode insulating layers 32 covers at least a portion of a different electrode current collector 140 in side surface 12. In the plan view of side surface 12, each of the plurality of electrode insulating layers 32 is elongated and extends in a direction perpendicular to the stacking direction of power generating element 5.

In side surface 12, each of the plurality of electrode insulating layers 32 covers a portion of counter electrode conductive connection portion 22, specifically, an end portion of counter electrode conductive connection portion 22 in the stacking direction of power generating element 5. Counter electrode conductive connection portions 22 other than counter electrode conductive connection portion 22 in the top-most portion have both end portions in the stacking direction of power generating element 5 covered by electrode insulating layer 32.

Each of the plurality of electrode insulating layers 32 is in contact with second inclined surface 22a of counter electrode conductive connection portion 22 and covers second inclined surface 22a. With this, electrode insulating layer 32 covers counter electrode conductive connection portion 22 as if pressing toward the center of counter electrode conductive connection portion 22, making it easier for force to be applied to the connection portion between counter electrode conductive connection portion 22 and counter electrode current collector 150, thereby enabling the connection between counter electrode conductive connection portion 22 and counter electrode current collector 150 to be made more robust. For example, due to the elastic force of electrode insulating layer 32, a force is generated by which electrode insulating layer 32 presses against counter electrode conductive connection portion 22. When power generating element 5 expands or contracts, or when battery 1 is sealed or the like, electrode insulating layer 32 readily applies pressure to press down on counter electrode conductive connection portion 22. Note that the plurality of counter electrode conductive connection portions 22 may include those that are not covered by electrode insulating layer 32.

As illustrated in FIG. 1, each of the plurality of electrode insulating layers 32 is positioned between side surface 12 and counter electrode conductive extraction layer 42. In this way, by battery 1 including a plurality of electrode insulating layers 32, short-circuiting due to contact between electrode current collector 140 and counter electrode conductive extraction layer 42 can be inhibited.

As illustrated in FIG. 1 and FIG. 4B, the plurality of electrode insulating layers 32 contact and cover the plurality of electrode current collectors 140 of power generating element 5 in side surface 12. In side surface 12, one electrode insulating layer 32 covers one electrode current collector 140. In the plan view of side surface 12, the plurality of electrode insulating layers 32 respectively overlap the plurality of electrode current collectors 140 and extend along the plurality of electrode current collectors 140. The plurality of electrode insulating layers 32 are in contact with and cover electrode layers 110 of the plurality of battery cells 100 in side surface 12. Electrode insulating layer 32 does not cover the plurality of counter electrode current collectors 150 of power generating element 5, and does not cover counter electrode layer 120 of each of the plurality of battery cells 100. Accordingly, in the plan view of side surface 12, the plurality of electrode insulating layers 32 are formed in a stripe shape. In the plan view of side surface 12, the plurality of electrode insulating layers 32 are aligned in the stacking direction of power generating element 5.

Electrode insulating layer 32 continuously covers electrode layers 110 of two adjacent battery cells 100. More specifically, electrode insulating layer 32 continuously covers a region from at least a portion of solid electrolyte layer 130 of one of two adjacent battery cells 100 to at least a portion of solid electrolyte layer 130 of the other of the two adjacent battery cells 100.

Thus, in side surface 12, electrode insulating layer 32 covers at least a portion of solid electrolyte layer 130. This reduces the risk of exposing electrode layer 110 even if the widths (lengths in the z-axis direction) of electrode insulating layers 32 differ due to manufacturing variations. This inhibits a short circuit between electrode layer 110 and counter electrode layer 120 via counter electrode conductive extraction layer 42, which is formed to cover electrode insulating layer 32. In addition, the end surface of solid electrolyte layer 130, which is formed of powdery material, has very fine irregularities. Electrode insulating layer 32 interlocks with these irregularities, which improves the adhesion strength of electrode insulating layer 32 and improves insulation reliability.

In the present embodiment, on side surface 12, the contour of electrode insulating layer 32 overlaps the boundary between solid electrolyte layer 130 and counter electrode layer 120. Electrode insulating layer 32 is not required to cover solid electrolyte layer 130 in side surface 12. For example, on side surface 12, the contour of electrode insulating layer 32 may overlap the boundary between solid electrolyte layer 130 and electrode layer 110. Electrode insulating layer 32 may cover a portion of counter electrode layer 120 in side surface 12.

In power generating element 5 according to the present embodiment, the bottom-most layer is electrode current collector 140. As illustrated in FIG. 1, in the vicinity of the bottom edge of side surface 12, electrode insulating layer 32 partially covers the main surface (i.e., main surface 16) of bottom-most electrode current collector 140. As a result, electrode insulating layer 32 is resistant to external forces, such as those from the z-axis direction, inhibiting detachment. Even if counter electrode conductive extraction layer 42 wraps around main surface 16 of power generating element 5, it can prevent a short circuit from occurring by contacting electrode current collector 140.

In this way, battery 1 includes counter electrode conductive connection portion 22 and electrode insulating layer 32, and in side surface 12, electrode insulating layer 32 covers a portion of counter electrode conductive connection portion 22. This allows the connection between the end portion of counter electrode current collector 150 and counter electrode conductive connection portion 22 to be firmly maintained.

More specifically, the connection portion between counter electrode current collector 150 and counter electrode conductive connection portion 22 on side surface 12 being robust is important for the performance, such as the reliability, of battery 1. However, since high conductivity performance is required for counter electrode conductive connection portion 22, there are cases where it is difficult to sufficiently enhance flexibility and adhesiveness. In view of this, by electrode insulating layer 32, which has a wider range of material selection than counter electrode conductive connection portion 22, covering and holding a portion of counter electrode conductive connection portion 22 connected to counter electrode current collector 150, the strength of the mechanical connection between counter electrode current collector 150 and counter electrode conductive connection portion 22 increases, and the connection between counter electrode current collector 150 and counter electrode conductive connection portion 22 can be maintained with low resistance and high reliability. Accordingly, it is possible to inhibit voltage loss caused by connection resistance, even during charging and discharging at high currents. With this, high current characteristics can be enhanced while both inhibiting heat generation at the connection portion between counter electrode current collector 150 and counter electrode conductive connection portion 22 and inhibiting strength degradation of the connection portion due to thermal expansion and deformation.

Counter electrode insulating layer 31 and electrode insulating layer 32 are each formed using an electrically insulating material. For example, counter electrode insulating layer 31 and electrode insulating layer 32 each include resin. With this, it is possible to enhance the impact resistance of battery 1, as well as ease the stress exerted on battery 1 due to temperature changes of battery 1 and expansion and contraction during charging and discharging. By counter electrode insulating layer 31 and electrode insulating layer 32 including resin, adhesiveness to the side surface of power generating element 5 and the conductive connection portion increases, and flexibility improves, effectively inhibiting the conductive connection portion from peeling off from the current collector. Resin is, for example, but not limited to, epoxy resin. The resin content of each of counter electrode insulating layer 31 and electrode insulating layer 32 may be greater than or equal to 50% by weight, and may be greater than or equal to 70% by weight. An inorganic material may be used as the insulating material. Available insulating materials are selected based on various properties such as flexibility, gas barrier, impact resistance, and heat resistance. Counter electrode insulating layer 31 and electrode insulating layer 32 are formed using the same material as each other, but may be formed using different materials.

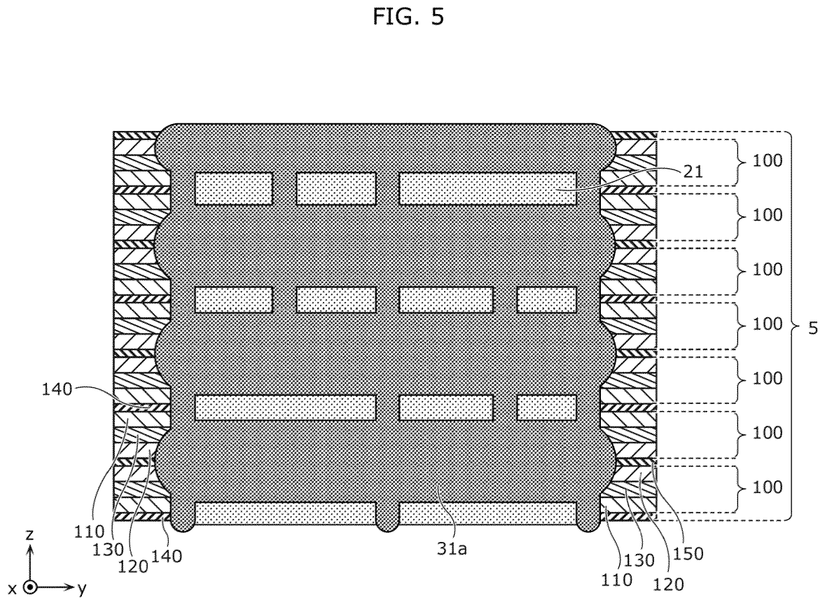

In FIG. 3 and FIG. 4A, separate counter electrode insulating layers 31 are provided per counter electrode current collector 150, but this example is non-limiting. For example, in addition to the stripe-shaped portion, counter electrode insulating layer 31 may have a portion provided along the z-axis direction. Stated differently, counter electrode insulating layer 31 may have a ladder shape or a grid shape in the plan view of side surface 11. FIG. 5 is a plan view illustrating another example of a counter electrode insulating layer according to the present embodiment. FIG. 5 is a plan view of side surface 11 with electrode conductive extraction layer 41 removed. As illustrated in FIG. 5, battery 1 may include counter electrode insulating layer 31a in place of counter electrode insulating layer 31. Counter electrode insulating layer 31a has a shape in which an insulating layer that traverses at least a portion of the plurality of counter electrode insulating layers 31 along the z-axis direction is applied to the plurality of counter electrode insulating layers 31. As such, counter electrode insulating layer 31a may include a portion that covers from the upper end to the lower end in the z-axis direction of a portion of electrode conductive connection portion 21. Similarly, for electrode insulating layer 32, for example, in addition to the stripe-shaped portion, electrode insulating layer 32 may have a portion provided along the z-axis direction. Stated differently, electrode insulating layer 32 may have a ladder shape or a grid shape in the plan view of side surface 12. Electrode insulating layer 32 may include a portion that covers from the upper end to the lower end in the z-axis direction of a portion of counter electrode conductive connection portion 22.

As illustrated in FIG. 1 and FIG. 4A, in side surface 11, electrode conductive extraction layer 41 covers a plurality of electrode conductive connection portions 21 and a plurality of counter electrode insulating layers 31, and is electrically connected to each of the plurality of electrode conductive connection portions 21. Electrode conductive extraction layer 41 is a conductive aggregation portion that electrically connects the plurality of electrode conductive connection portions 21 collectively. Electrode conductive extraction layer 41 is in contact with the plurality of electrode conductive connection portions 21 in portions where the plurality of electrode conductive connection portions 21 are not covered by counter electrode insulating layer 31. In the illustrated example, in the plan view of side surface 11, electrode conductive extraction layer 41 does not overlap a portion of counter electrode insulating layer 31. Electrode conductive extraction layer 41 may overlap the entire counter electrode insulating layer 31 in the plan view of side surface 11.

Electrode conductive extraction layer 41 is electrically connected to each of the plurality of electrode current collectors 140, and to electrode layer 110 of each of the plurality of battery cells 100, via the plurality of electrode conductive connection portions 21. Stated differently, electrode conductive extraction layer 41 serves to electrically connect each battery cell 100 in parallel. Electrode conductive extraction layer 41 can extract current from electrode layer 110 of the entire battery 1. As illustrated in FIG. 1 and FIG. 4A, electrode conductive extraction layer 41 covers almost the entire side surface 11 from the bottom to the top.

In this way, in side surface 11, battery 1 includes electrode conductive extraction layer 41 that covers at least a portion of counter electrode insulating layer 31 and is electrically connected to electrode conductive connection portion 21, making it possible to easily realize the extraction electrode for electrode layer 110 of battery 1.

As illustrated in FIG. 1 and FIG. 4B, in side surface 12, counter electrode conductive extraction layer 42 covers a plurality of counter electrode conductive connection portions 22 and a plurality of electrode insulating layers 32, and is electrically connected to each of the plurality of counter electrode conductive connection portions 22. Counter electrode conductive extraction layer 42 is a conductive aggregation portion that electrically connects the plurality of counter electrode conductive connection portions 22 collectively. Counter electrode conductive extraction layer 42 is in contact with the plurality of counter electrode conductive connection portions 22 in portions where the plurality of counter electrode conductive connection portions 22 are not covered by electrode insulating layer 32. In the illustrated example, in the plan view of side surface 12, counter electrode conductive extraction layer 42 does not overlap a portion of electrode insulating layer 32. Counter electrode conductive extraction layer 42 may overlap the entire electrode insulating layer 32 in the plan view of side surface 12.

Counter electrode conductive extraction layer 42 is electrically connected to each of the plurality of counter electrode current collectors 150, and to counter electrode layer 120 of each of the plurality of battery cells 100, via the plurality of counter electrode conductive connection portions 22. Stated differently, counter electrode conductive extraction layer 42 serves to electrically connect each battery cell 100 in parallel. Counter electrode conductive extraction layer 42 can extract current from counter electrode layer 120 of entire battery 1. As illustrated in FIG. 1 and FIG. 4B, counter electrode conductive extraction layer 42 covers almost entire side surface 12 from the bottom to the top.

In this way, in side surface 12, battery 1 includes counter electrode conductive extraction layer 42 that covers at least a portion of electrode insulating layer 32 and is electrically connected to counter electrode conductive connection portion 22, making it possible to easily realize the extraction electrode for counter electrode layer 120 of battery 1.

Electrode conductive extraction layer 41 and counter electrode conductive extraction layer 42 are each formed using a conductive resin material or the like. The conductive resin material includes, for example, a resin and a conductive material of metal particles or the like filled in the resin. Alternatively, electrode conductive extraction layer 41 and counter electrode conductive extraction layer 42 may each be formed using a metallic material such as solder. Available conductive materials are selected based on various properties such as flexibility, gas barrier, impact resistance, and heat resistance. Electrode conductive extraction layer 41 and counter electrode conductive extraction layer 42 are formed using the same material as each other, but may be formed using different materials. Electrode conductive extraction layer 41 and counter electrode conductive extraction layer 42 may be formed using the same material as electrode conductive connection portion 21 and counter electrode conductive connection portion 22, or may be formed using different materials. When electrode conductive extraction layer 41 and counter electrode conductive extraction layer 42 are formed using different materials from electrode conductive connection portion 21 and counter electrode conductive connection portion 22, for example, by appropriately combining materials that differ in at least one of hardness, adhesiveness, conductivity, or corrosion resistance, battery characteristics or durability can be improved. For example, electrode conductive extraction layer 41 and counter electrode conductive extraction layer 42 may be harder than electrode conductive connection portion 21 and counter electrode conductive connection portion 22.

### Sizes of Conductive Connection Portion, Insulating Layer, and Conductive Extraction Layer

Here, the sizes of electrode conductive connection portion 21, counter electrode conductive connection portion 22, counter electrode insulating layer 31, electrode insulating layer 32, electrode conductive extraction layer 41, and counter electrode conductive extraction layer 42 will be described with reference to FIG. 4A and FIG. 4B.

As illustrated in FIG. 4A, in the plan view of side surface 11, the length of each of the plurality of electrode conductive connection portions 21 in the direction (y-axis direction) perpendicular to the stacking direction of power generating element 5 is longer than the length of electrode conductive extraction layer 41 in the direction (y-axis direction) perpendicular to the stacking direction of power generating element 5. Electrode conductive extraction layer 41, in the y-axis direction, is positioned inward from both ends of each of the plurality of electrode conductive connection portions 21. In the plan view of side surface 11, each of the plurality of electrode conductive connection portions 21 includes a region that is not covered by electrode conductive extraction layer 41.

In battery 1, the part where connection resistance is most likely to become largest is the interface between the current collector and the conductive connection portion, and by increasing the length of electrode conductive connection portion 21, the connection area between electrode current collector 140 and electrode conductive connection portion 21 can be increased, thereby reducing the connection resistance between electrode current collector 140 and electrode conductive connection portion 21. By increasing the length of electrode conductive connection portion 21, the connection resistance between electrode current collector 140 and electrode conductive connection portion 21 can be made more uniform in a direction perpendicular to the stacking direction of power generating element 5 and in which electrode current collector 140 extends on side surface 11. In particular, during high-speed charging and discharging where current density becomes large, by reducing the connection resistance and increasing the connection range between electrode current collector 140 and electrode conductive connection portion 21 to prevent current from concentrating in part of electrode current collector 140, performance and safety aspects can be improved.

However, since electrode conductive extraction layer 41 is a portion through which the total current of the entire battery 1 flows, by making the length of electrode conductive extraction layer 41 shorter than the length of electrode conductive connection portion 21, contact with other areas can be inhibited, enhancing the safety of battery 1. By reducing the size of electrode conductive extraction layer 41, the weight and volume of battery 1 can be reduced, enabling improvement of energy density and reduction of cost.

In the plan view of side surface 11, the length of each of the plurality of electrode conductive connection portions 21 in the direction (y-axis direction) perpendicular to the stacking direction of power generating element 5 is shorter than the length of power generating element 5 in the direction (y-axis direction) perpendicular to the stacking direction of power generating element 5. The corner portions of power generating element 5 are the most mechanically vulnerable parts within power generating element 5, and therefore, compared to other parts, they are more prone to collapse or other damage, for example, when impacted. Therefore, by making the length of electrode conductive connection portion 21 shorter than the length of power generating element 5, electrode conductive connection portion 21 is not formed at the end portion in the y-axis direction of side surface 11, and even if collapse does occur in power generating element 5, short-circuiting via electrode conductive connection portion 21 can be inhibited. Accordingly, the reliability of battery 1 can be improved.

The length of electrode conductive connection portion 21 may be the same as the length of power generating element 5. Electrode conductive connection portion 21 may be formed extending from side surface 11 to side surfaces other than side surface 11 among the side surfaces of power generating element 5. For example, electrode conductive connection portion 21 may be formed extending from side surface 11 to side surface 12. In such cases, for example, electrode conductive connection portion 21 is connected to electrode current collector 140 on side surface 11 as well as on side surface 12 where counter electrode conductive connection portion 22 is formed. On side surface 12, electrode conductive connection portion 21 is covered by electrode insulating layer 32, and counter electrode conductive extraction layer 42 and electrode conductive connection portion 21 oppose each other with electrode insulating layer 32 therebetween. This allows the connection area between electrode conductive connection portion 21 and electrode current collector 140 to be further increased. Electrode conductive connection portion 21 may be formed to surround power generating element 5 along the outer periphery of power generating element 5 when viewed from the stacking direction.

In the example illustrated in FIG. 4A, in the plan view of side surface 11, the length of each of the plurality of counter electrode insulating layers 31 in the direction (y-axis direction) perpendicular to the stacking direction of power generating element 5 is longer than the length of electrode conductive connection portion 21 and the length of electrode conductive extraction layer 41. This allows the reliability of battery 1 to be further improved. The plurality of electrode conductive connection portions 21 and electrode conductive extraction layer 41, in the y-axis direction, are positioned inward from both ends of each of the plurality of counter electrode insulating layers 31. In the plan view of side surface 11, the length of counter electrode insulating layer 31 in the direction (y-axis direction) perpendicular to the stacking direction of power generating element 5 may be shorter than the length of power generating element 5, may be the same as the length of power generating element 5, or may be longer than the length of power generating element 5. Although the plurality of counter electrode insulating layers 31 have the same length in the y-axis direction in the example illustrated in FIG. 4A, the plurality counter electrode insulating layers 31 may include those of different lengths in the y-axis direction.

Note that the plurality of electrode conductive connection portions 21 may include those whose length is shorter than the length of electrode conductive extraction layer 41. The plurality of counter electrode insulating layers 31 may include those whose length in the y-axis direction is shorter than the length of electrode conductive connection portion 21.

As illustrated in FIG. 4B, in the plan view of side surface 12, the length of each of the plurality of counter electrode conductive connection portions 22 in the direction (y-axis direction) perpendicular to the stacking direction of power generating element 5 is longer than the length of counter electrode conductive extraction layer 42 in the direction (y-axis direction) perpendicular to the stacking direction of power generating element 5. Counter electrode conductive extraction layer 42, in the y-axis direction, is positioned inward from both ends of each of the plurality of counter electrode conductive connection portions 22. In the plan view of side surface 12, each of the plurality of counter electrode conductive connection portions 22 includes a region that is not covered by counter electrode conductive extraction layer 42.

In battery 1, the part where connection resistance is most likely to become largest is the interface between the current collector and the conductive connection portion, and by increasing the length of counter electrode conductive connection portion 22, the connection area between counter electrode current collector 150 and counter electrode conductive connection portion 22 can be increased, thereby reducing the connection resistance between counter electrode current collector 150 and counter electrode conductive connection portion 22. By increasing the length of counter electrode conductive connection portion 22, the connection resistance between counter electrode current collector 150 and counter electrode conductive connection portion 22 can be made more uniform in a direction perpendicular to the stacking direction of power generating element 5 and in which counter electrode current collector 150 extends on side surface 12. In particular, during high-speed charging and discharging where current density becomes large, by reducing the connection resistance and increasing the connection range between counter electrode current collector 150 and counter electrode conductive connection portion 22 to prevent current from concentrating in part of counter electrode current collector 150, performance and safety aspects can be improved.

However, since counter electrode conductive extraction layer 42 is a portion through which the total current of the entire battery 1 flows, by making the length of counter electrode conductive extraction layer 42 shorter than the length of counter electrode conductive connection portion 22, contact with other areas can be inhibited, enhancing the safety of battery 1. By reducing the size of counter electrode conductive extraction layer 42, the weight and volume of battery 1 can be reduced, enabling improvement of energy density and reduction of cost.

In the plan view of side surface 12, the length of each of the plurality of counter electrode conductive connection portions 22 in the direction (y-axis direction) perpendicular to the stacking direction of power generating element 5 is shorter than the length of power generating element 5 in the direction (y-axis direction) perpendicular to the stacking direction of power generating element 5. The corner portions of power generating element 5 are the most mechanically vulnerable parts within power generating element 5, and therefore, compared to other parts, they are more prone to collapse or other damage, for example, when impacted. Therefore, by making the length of counter electrode conductive connection portion 22 shorter than the length of power generating element 5, counter electrode conductive connection portion 22 is not formed at the end portion in the y-axis direction of side surface 12, and even if collapse does occur in power generating element 5, short-circuiting via counter electrode conductive connection portion 22 can be inhibited. Accordingly, the reliability of battery 1 can be improved.

The length of counter electrode conductive connection portion 22 may be the same as the length of power generating element 5. Counter electrode conductive connection portion 22 may be formed extending from side surface 12 to side surfaces other than side surface 12 among the side surfaces of power generating element 5. For example, counter electrode conductive connection portion 22 may be formed extending from side surface 12 to side surface 11. In such cases, for example, counter electrode conductive connection portion 22 is connected to counter electrode current collector 150 on side surface 12 as well as on side surface 11 where electrode conductive connection portion 21 is formed. On side surface 11, counter electrode conductive connection portion 22 is covered by counter electrode insulating layer 31, and electrode conductive extraction layer 41 and counter electrode conductive connection portion 22 oppose each other with counter electrode insulating layer 31 therebetween. This allows the connection area between counter electrode conductive connection portion 22 and counter electrode current collector 150 to be further increased. Counter electrode conductive connection portion 22 may be formed to surround power generating element 5 along the outer periphery of power generating element 5 when viewed from the stacking direction.

In the example illustrated in FIG. 4B, in the plan view of side surface 12, the length of each of the plurality of electrode insulating layers 32 in the direction (y-axis direction) perpendicular to the stacking direction of power generating element 5 is longer than the length of counter electrode conductive connection portion 22 and the length of counter electrode conductive extraction layer 42. This allows the reliability of battery 1 to be further improved. The plurality of counter electrode conductive connection portions 22 and counter electrode conductive extraction layer 42, in the y-axis direction, are positioned inward from both ends of each of the plurality of electrode insulating layers 32. In the plan view of side surface 12, the length of electrode insulating layer 32 in the direction (y-axis direction) perpendicular to the stacking direction of power generating element 5 may be shorter than the length of power generating element 5, may be the same as the length of power generating element 5, or may be longer than the length of power generating element 5. Although the plurality of electrode insulating layers 32 have the same length in the y-axis direction in the example illustrated in FIG. 4B, the plurality of electrode insulating layers 32 may include those of different lengths in the y-axis direction.

Note that the plurality of counter electrode conductive connection portions 22 may include those whose length is shorter than the length of counter electrode conductive extraction layer 42. The plurality of electrode insulating layers 32 may include those whose length in the y-axis direction is shorter than the length of counter electrode conductive connection portion 22.

### Current Collecting Terminal

Next, electrode current collecting terminal 51 and counter electrode current collecting terminal 52 will be described.

As illustrated in FIG. 1, electrode current collecting terminal 51 is a conductive terminal electrically connected to electrode conductive extraction layer 41. Electrode current collecting terminal 51 is one of the external connection terminals of battery 1, and in the present embodiment, is an anode extraction terminal. Electrode current collecting terminal 51 is arranged on main surface 16 of power generating element 5. Stated differently, electrode current collecting terminal 51 is provided on main surface 16. Note that a terminal being provided on a main surface means not only cases where the terminal is directly arranged on the main surface, but also cases where the terminal is arranged on the main surface with another layer disposed therebetween.

As illustrated in FIG. 1, electrode current collecting terminal 51 is arranged on main surface 16 away from side surface 11. Stated differently, electrode conductive connection portion 21 and electrode conductive extraction layer 41 are provided so as to cover the region of main surface 16 between side surface 11 and electrode current collecting terminal 51. Electrode conductive extraction layer 41 continuously covers from side surface 11 to main surface 16, and is connected in contact with electrode current collecting terminal 51.

In the present embodiment, electrode current collecting terminal 51 has, for example, higher conductivity than electrode current collector 140. The thickness (length in the z-axis direction) of electrode current collecting terminal 51 is, for example, greater than the thickness of electrode current collector 140. The makes it possible to increase the conductivity of electrode current collecting terminal 51 and reduce the resistance of the extraction electrode structure.

As illustrated in FIG. 1, counter electrode current collecting terminal 52 is a conductive terminal electrically connected to counter electrode conductive extraction layer 42. Counter electrode current collecting terminal 52 is one of the external connection terminals of battery 1, and in the present embodiment, is a cathode extraction terminal. Counter electrode current collecting terminal 52 is arranged on main surface 15 of power generating element 5. Stated differently, counter electrode current collecting terminal 52 is provided on main surface 15.

As illustrated in FIG. 1, counter electrode current collecting terminal 52 is arranged on main surface 15 away from side surface 12. Stated differently, counter electrode conductive connection portion 22 and counter electrode conductive extraction layer 42 are provided so as to cover the region of main surface 15 between side surface 12 and counter electrode current collecting terminal 52. Counter electrode conductive extraction layer 42 continuously covers from side surface 12 to main surface 15, and is connected in contact with counter electrode current collecting terminal 52.

In the present embodiment, counter electrode current collecting terminal 52 has, for example, higher conductivity than counter electrode current collector 150. The thickness (length in the z-axis direction) of counter electrode current collecting terminal 52 is, for example, greater than the thickness of counter electrode current collector 150. This makes it possible to increase the conductivity of counter electrode current collecting terminal 52 and reduce the resistance of the extraction electrode structure.

In this way, by electrically connecting electrode current collecting terminal 51 to electrode conductive extraction layer 41 and electrically connecting counter electrode current collecting terminal 52 to counter electrode conductive extraction layer 42, the routing of the extraction electrodes can be simplified. In the present embodiment, electrode current collecting terminal 51 and counter electrode current collecting terminal 52 are provided on different main surfaces of power generating element 5, specifically, on one main surface 16 and the other main surface 15, respectively. Since two terminals with different polarities are arranged apart from each other, the occurrence of a short circuit can be inhibited. Battery 1 can be used by clamping it between wiring terminals, allowing for easy attachment and detachment.

Electrode current collecting terminal 51 and counter electrode current collecting terminal 52 are each formed using a material having conductivity. For example, electrode current collecting terminal 51 and counter electrode current collecting terminal 52 are metal foils or metal plates of, for example, copper, aluminum, or stainless steel. Alternatively, electrode current collecting terminal 51 and counter electrode current collecting terminal 52 may each be a conductive resin or cured solder.

Electrode current collecting terminal 51 and counter electrode current collecting terminal 52 may each be directly bonded to a main surface of power generating element 5, or may be bonded to a main surface of power generating element 5 with an intermediate layer therebetween. Here, when electrode current collecting terminal 51 and the current collector including main surface 16 on which electrode current collecting terminal 51 is provided have the same polarity, the intermediate layer may be either conductive or insulating. However, when electrode current collecting terminal 51 and the current collector including main surface 16 on which electrode current collecting terminal 51 is provided have different polarities, the intermediate layer is insulating. Similarly, when counter electrode current collecting terminal 52 and current collector including main surface 15 on which counter electrode current collecting terminal 52 is provided have the same polarity, the intermediate layer may be either conductive or insulating. However, when counter electrode current collecting terminal 52 and the current collector including main surface 15 on which counter electrode current collecting terminal 52 is provided have different polarities, the intermediate layer is insulating.

The functions of electrode current collecting terminal 51 and counter electrode current collecting terminal 52 may be realized by the current collector including the main surface of power generating element 5. For example, the electrode current collecting terminal may be electrode current collector 140 of the bottom-most layer of power generating element 5. The counter electrode current collecting terminal may be counter electrode current collector 150 of the top-most layer of power generating element 5. In this case, electrode current collector 140 and counter electrode current collector 150 functioning as current collecting terminals may be thicker than other electrode current collectors 140 and counter electrode current collectors 150. The functions of electrode current collecting terminal 51 and counter electrode current collecting terminal 52 may be realized by electrode conductive extraction layer 41 and counter electrode conductive extraction layer 42.

### Other Configurations

Battery 1 may be used in a battery that includes outer case that houses battery 1. The reliability of battery 1 can be improved by battery 1 being housed in the outer case.

When there is a space between the outer case and battery 1, battery 1 may collide with the inner surface of the outer case due to vibration and other factors. This collision often occurs at an end portion of battery 1, and consequently, the impact during collision is often applied to the area around an end portion of battery 1. In battery 1 where a portion of electrode conductive connection portion 21 is covered by counter electrode insulating layer 31, it is effective for both improving current collection performance by reducing connection resistance through robustly maintaining the connection between electrode current collector 140 and electrode conductive connection portion 21, and achieving reliability by inhibiting delamination of electrode conductive connection portion 21 due to impact or the like to the area around an end portion of battery 1. This is also true for counter electrode conductive connection portion 22 and electrode insulating layer 32.

A vacuum laminate film may be used as the outer case. This reduces the gap with battery 1, thereby increasing the overall energy density. When the outer case and battery 1 are in close contact, such as when using a vacuum laminate film as the outer case, there is a risk of damage to battery 1 due to impact and pressure applied from the outer surface of the outer case. Even in this case, in battery 1 where a part of electrode conductive connection portion 21 is covered by counter electrode insulating layer 31, it is effective for both improving current collection performance and improving reliability against impact applied to the area around an end portion of battery 1.

The method for extracting terminals from the outer case is not particularly limited; for example, a method of leading terminals to the outside of the outer case and using an insulating thermal seal can be employed.

Note that the batteries according to each embodiment to be described hereinafter may also be used as batteries housed in an outer case.

### Embodiment 2

Next, Embodiment 2 will be described. Hereinafter, the description will focus on the differences from Embodiment 1, while omitting or simplifying the description of common points.

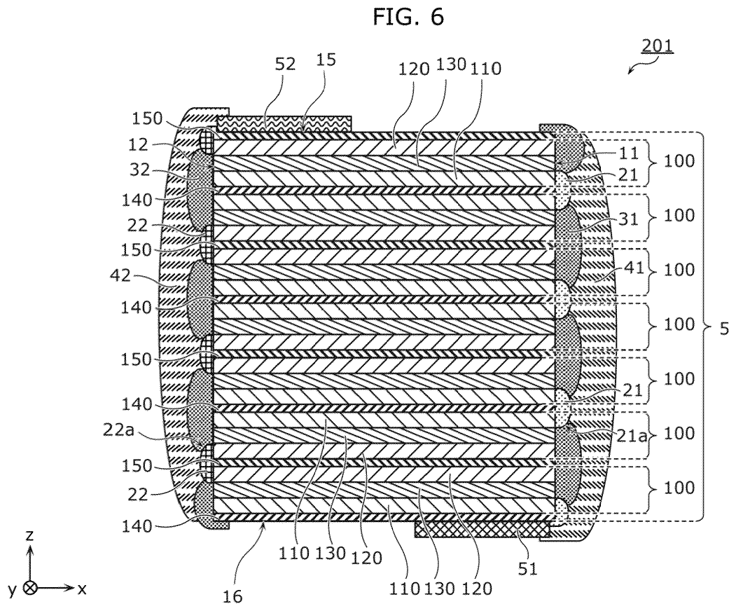

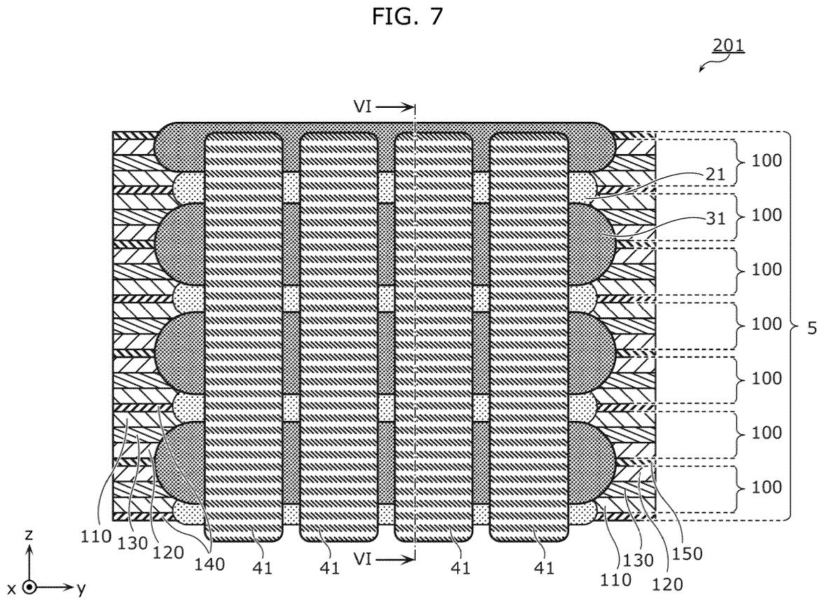

FIG. 6 is a cross-sectional view of battery 201 according to the present embodiment. FIG. 7 is a side view of battery 201 according to the present embodiment. More specifically, FIG. 6 illustrates a cross section taken along line VI-VI illustrated in FIG. 7. FIG. 7 is a plan view of battery 201 when viewed from the positive x-axis direction. FIG. 7 can also be said to be a plan view of side surface 11.

Battery 201 according to the present embodiment differs from battery 1 according to Embodiment 1 in that it includes a plurality of electrode conductive extraction layers 41 and a plurality of counter electrode conductive extraction layers 42.

As illustrated in FIG. 7, battery 201 includes a plurality of electrode conductive extraction layers 41. As illustrated in FIG. 7, battery 201 includes four electrode conductive extraction layers 41, the number of electrode conductive extraction layers 41 is not particularly limited as long as it is two or greater. In the plan view of side surface 11, the plurality of electrode conductive extraction layers 41 are aligned in a direction (the y-axis direction) perpendicular to the stacking direction of power generating element 5. The plurality of electrode conductive extraction layers 41 may, for example, include electrode conductive extraction layers 41 that are all connected in contact with electrode current collecting terminal 51, but may also include electrode conductive extraction layers 41 that are not connected in contact with electrode current collecting terminal 51.

In the plan view of side surface 11, the length of each of the plurality of electrode conductive connection portions 21 in the direction (y-axis direction) perpendicular to the stacking direction of power generating element 5 is longer than the length of each of the plurality of electrode conductive extraction layers 41 in the direction (y-axis direction) perpendicular to the stacking direction of power generating element 5. In the example illustrated in FIG. 7, although the length of each of the plurality of electrode conductive extraction layers 41 is the same, the length of at least one electrode conductive extraction layer 41 may be different from the rest.

In the example illustrated in FIG. 7, in the plan view of side surface 11, the length of each of the plurality of electrode conductive connection portions 21 in the direction (y-axis direction) perpendicular to the stacking direction of power generating element 5 is longer than the total of lengths of each of the plurality of electrode conductive extraction layers 41 in the direction (y-axis direction) perpendicular to the stacking direction of power generating element 5. Each of the plurality of electrode conductive extraction layers 41, in the y-axis direction, is positioned inward from both ends of each of the plurality of electrode conductive connection portions 21. The spacing between two adjacent electrode conductive extraction layers 41 is, for example, shorter than the length of each of the plurality of electrode conductive extraction layers 41. In the example illustrated in FIG. 7, although each spacing is the same, at least one spacing may be different from the rest.

In this way, by battery 201 including a plurality of electrode conductive extraction layers 41, even if the length of electrode conductive extraction layer 41 becomes shorter compared to when including only one electrode conductive extraction layer 41, the connection area between the plurality of electrode conductive extraction layers 41 and the plurality of electrode conductive connection portions 21 can be ensured. Moreover, since the length of individual electrode conductive extraction layers 41 can be shortened, while still ensuring the connection area, compared to when including only one electrode conductive extraction layer 41, the internal stress of electrode conductive extraction layer 41 can be alleviated. Even when electrode conductive extraction layer 41 thermally expands due to temperature rising during charging and discharging at high currents, embrittlement and delamination of electrode conductive extraction layer 41 can be inhibited. Since the length of individual electrode conductive extraction layers 41 can be shortened, when forming electrode conductive extraction layer 41 by coating or the like, air between electrode conductive extraction layer 41 and the coating surface can be more easily discharged, whereby delamination of electrode conductive extraction layer 41 can be inhibited. Even when pressing electrode conductive extraction layer 41 to discharge the air, the pressure used can be reduced, inhibiting damage to power generating element 5.

Battery 201 includes a plurality of counter electrode conductive extraction layers 42, similar to electrode conductive extraction layers 41. Although not illustrated in the drawings, similar to the plurality of electrode conductive extraction layers 41, the plurality of counter electrode conductive extraction layers 42 are aligned in a direction (the y-axis direction) perpendicular to the stacking direction of power generating element 5 in the plan view of side surface 12. The plurality of counter electrode conductive extraction layers 42 may, for example, include counter electrode conductive extraction layers 42 that are all connected in contact with counter electrode current collecting terminal 52, but may also include counter electrode conductive extraction layers 42 that are not connected in contact with counter electrode current collecting terminal 52.

Similarly to battery 1, in the plan view of side surface 12, the length of each of the plurality of counter electrode conductive connection portions 22 in the direction (y-axis direction) perpendicular to the stacking direction of power generating element 5 is longer than the length of each of the plurality of counter electrode conductive extraction layers 42 in the direction (y-axis direction) perpendicular to the stacking direction of power generating element 5. The length of each of the plurality of counter electrode conductive extraction layers 42 may be the same, or the length of at least one counter electrode conductive extraction layer 42 may be different from the rest.

Similarly to the plurality of electrode conductive extraction layers 41 on side surface 11, in the plan view of side surface 12, the length of each of the plurality of counter electrode conductive connection portions 22 in the direction (y-axis direction) perpendicular to the stacking direction of power generating element 5 is, for example, longer than the total of lengths of each of the plurality of counter electrode conductive extraction layers 42 in the direction (y-axis direction) perpendicular to the stacking direction of power generating element 5. Each of the plurality of counter electrode conductive extraction layers 42, in the y-axis direction, is positioned inward from both ends of each of the plurality of counter electrode conductive connection portions 22. The spacing between two adjacent counter electrode conductive extraction layers 42 is, for example, shorter than the length of each of the plurality of counter electrode conductive extraction layers 42. Each spacing may be the same, or at least one spacing may be different from the rest.

In this way, by battery 201 including a plurality of counter electrode conductive extraction layers 42, even if the length of counter electrode conductive extraction layer 42 becomes shorter compared to when including only one counter electrode conductive extraction layer 42, the connection area between the plurality of counter electrode conductive extraction layers 42 and the plurality of counter electrode conductive connection portions 22 can be ensured. Moreover, since the length of individual counter electrode conductive extraction layers 42 can be shortened, while still ensuring the connection area, compared to when including only one counter electrode conductive extraction layer 42, the internal stress of counter electrode conductive extraction layer 42 can be alleviated. Even when counter electrode conductive extraction layer 42 thermally expands due to temperature rising during charging and discharging at high currents, embrittlement and delamination of counter electrode conductive extraction layer 42 can be inhibited. Since the length of individual counter electrode conductive extraction layers 42 can be shortened, when forming counter electrode conductive extraction layer 42 by coating or the like, air between counter electrode conductive extraction layer 42 and the coating surface can be more easily discharged, whereby delamination of counter electrode conductive extraction layer 42 can be inhibited. Even when pressing counter electrode conductive extraction layer 42 to discharge the air, the pressure used can be reduced, inhibiting damage to power generating element 5.

### Embodiment 3

Next, Embodiment 3 will be described. Hereinafter, the description will focus on the differences from Embodiments 1 and 2, while omitting or simplifying the description of common points.

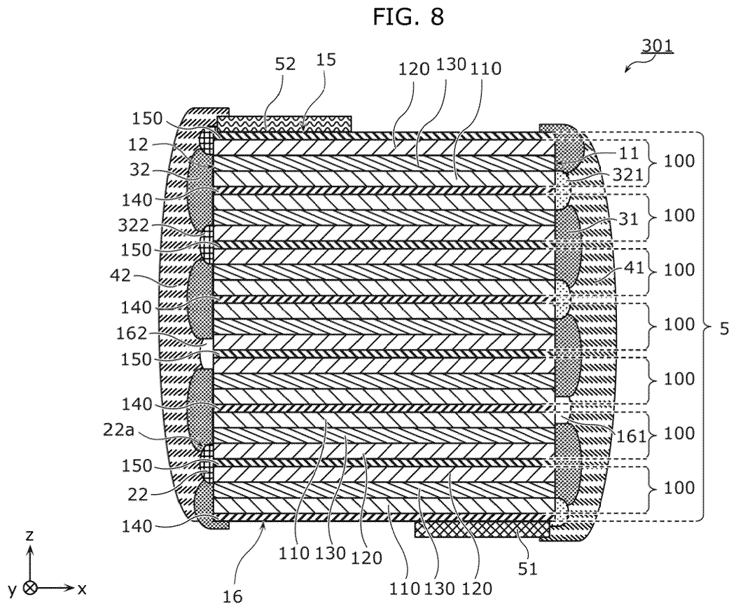

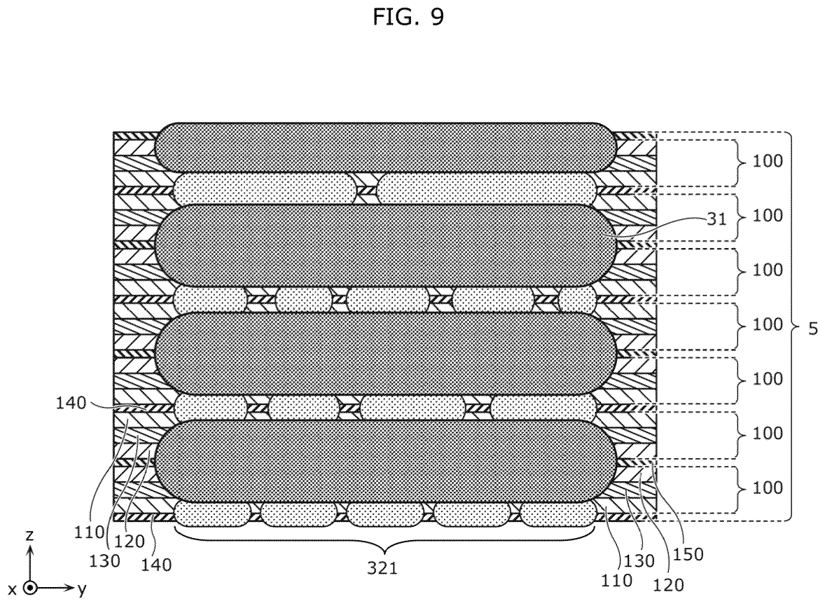

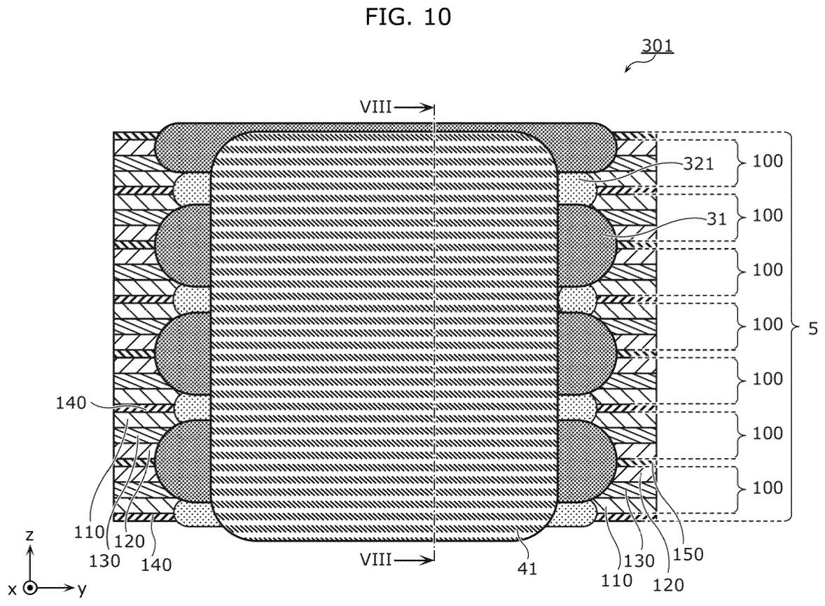

FIG. 8 is a cross-sectional view of battery 301 according to the present embodiment. FIG. 9 is a plan view of power generating element 5 of battery 301 according to the present embodiment when viewed from the side (positive x-axis direction). FIG. 10 is a side view of battery 301 according to the present embodiment. More specifically, FIG. 8 illustrates a cross section taken along line VIII-VIII illustrated in FIG. 10. FIG. 9 illustrates a state during manufacturing of battery 301, and is a view of battery 301 with electrode conductive extraction layer 41 removed. FIG. 9 illustrates the state of battery 301 at one of the manufacturing stages for Battery 301. FIG. 10 is a plan view of battery 301 when viewed from the positive x-axis direction. FIG. 9 and FIG. 10 can also be said to be plan views of side surface 11.

Battery 301 according to the present embodiment differs from battery 1 according to Embodiment 1 in that it includes a plurality of electrode conductive connection portions 321 and a plurality of counter electrode conductive connection portions 322 instead of a plurality of electrode conductive connection portions 21 and a plurality of counter electrode conductive connection portions 22. Battery 301 according to the present embodiment differs from battery 1 according to Embodiment 1 in that it includes void 161 and void 162. Note that battery 301 need not include at least one of void 161 or void 162.

As illustrated in FIG. 9, each of the plurality of electrode conductive connection portions 321 is formed in a divided manner in the plan view of side surface 11, and has the same configuration as the plurality of electrode conductive connection portions 21 except that it is in the form of an elongated, broken line extending in a direction perpendicular to the stacking direction of power generating element 5. In the plan view of side surface 11, by electrode conductive connection portion 321 being in the form of a broken line, the internal stress of electrode conductive connection portion 321 can be dispersed and alleviated. Even when electrode conductive connection portion 321 thermally expands due to temperature rising during charging and discharging at high currents, embrittlement and delamination of electrode conductive connection portion 321 can be inhibited. Note that in the example illustrated in FIG. 9, all electrode conductive connection portions 321 are in the form of broken lines, but battery 301 may include electrode conductive connection portions 21 in the form of solid lines in place of some of electrode conductive connection portions 321.

As illustrated in FIG. 10, electrode conductive extraction layer 41, in the y-axis direction, is positioned inward from both ends of each of the plurality of electrode conductive connection portions 321. In the plan view of side surface 11, each of the plurality of electrode conductive connection portions 321 includes a region that is not covered by electrode conductive extraction layer 41. Note that a portion of the individual portions of electrode conductive connection portion 321 divided into broken lines need not overlap electrode conductive extraction layer 41 in the plan view of side surface 11.

Although not illustrated in the drawings, similar to the plurality of electrode conductive connection portions 321, each of the plurality of counter electrode conductive connection portions 322 is formed in a divided manner in the plan view of side surface 12, and has the same configuration as the plurality of counter electrode conductive connection portions 22 except that it is in the form of an elongated, broken line extending in a direction perpendicular to the stacking direction of power generating element 5. In the plan view of side surface 12, by counter electrode conductive connection portion 322 being in the form of a broken line, the internal stress of counter electrode conductive connection portion 322 can be dispersed and alleviated. Even when counter electrode conductive connection portion 322 thermally expands due to temperature rising during charging and discharging at high currents, embrittlement and delamination of counter electrode conductive connection portion 322 can be inhibited. Note that all counter electrode conductive connection portions 322 may be in the form of broken lines, and, alternatively, battery 301 may include counter electrode conductive connection portions 22 in the form of solid lines in place of some of counter electrode conductive connection portions 322.

Counter electrode conductive extraction layer 42, in the y-axis direction, is positioned inward from both ends of each of the plurality of counter electrode conductive connection portions 322. In the plan view of side surface 12, each of the plurality of counter electrode conductive connection portions 322 includes a region that is not covered by counter electrode conductive extraction layer 42. Note that a portion of the individual portions of counter electrode conductive connection portion 322 divided into broken lines need not overlap counter electrode conductive extraction layer 42 in the plan view of side surface 12.

Note that battery 201 described above may include electrode conductive connection portions 321 and counter electrode conductive connection portions 322.

Void 161 is formed, for example, in the gaps of electrode conductive connection portion 321 divided into broken lines. In the present embodiment, void 161 is surrounded by an inner wall formed by side surface 11, electrode conductive connection portion 321, counter electrode insulating layer 31, and electrode conductive extraction layer 41. As a result of void 161 being formed in battery 301, void 161 functions as a buffer space against internal stress due to expansion and contraction of battery 301 and against mechanical shock. Moreover, by electrode conductive connection portion 321 being in the form of a broken line, void 161 can be easily formed in battery 301.

Void 162 is formed, for example, in the gaps of counter electrode conductive connection portion 322 divided into broken lines. In the present embodiment, void 162 is surrounded by an inner wall formed by side surface 12, counter electrode conductive connection portion 322, electrode insulating layer 32, and counter electrode conductive extraction layer 42. As a result of void 162 being formed in battery 301, void 162 functions as a buffer space against internal stress due to expansion and contraction of battery 301 and against mechanical shock. Moreover, by counter electrode conductive connection portion 322 being in the form of a broken line, void 162 can be easily formed in battery 301.

Note that the positions where void 161 and void 162 are formed are not limited to the above-described examples, and may be formed at any location outside side surface 11 and outside side surface 12 of power generating element 5 in battery 301. For example, the void may be a void surrounded by an inner wall formed by at least one selected from the group consisting of side surface 11, the plurality of electrode conductive connection portions 21, electrode conductive extraction layer 41, and counter electrode insulating layer 31. Moreover, the void may be a void surrounded by an inner wall formed by at least one selected from the group consisting of side surface 12, the plurality of counter electrode conductive connection portions 22, counter electrode conductive extraction layer 42, and electrode insulating layer 32. Furthermore, a void may be formed in the above-described battery 1 or battery 201.

### Embodiment 4

Next, Embodiment 4 will be described. Hereinafter, the description will focus on the differences from Embodiments 1 to 3, while omitting or simplifying the description of common points.

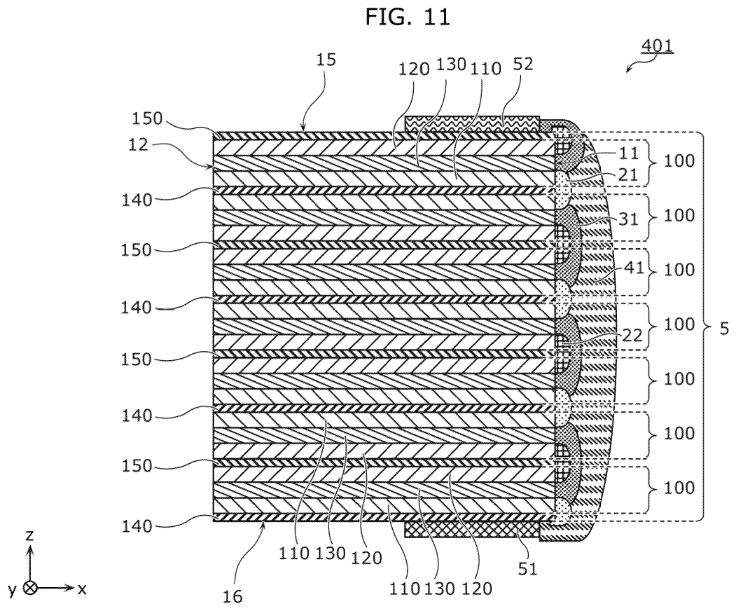

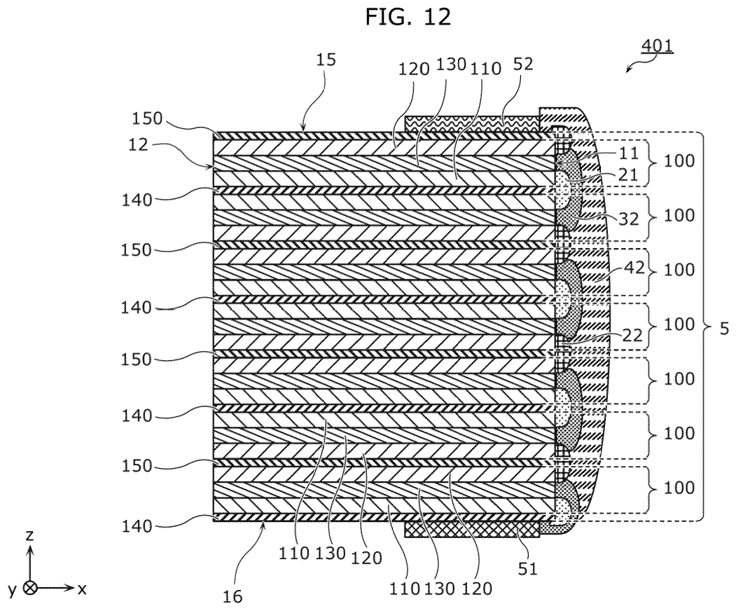

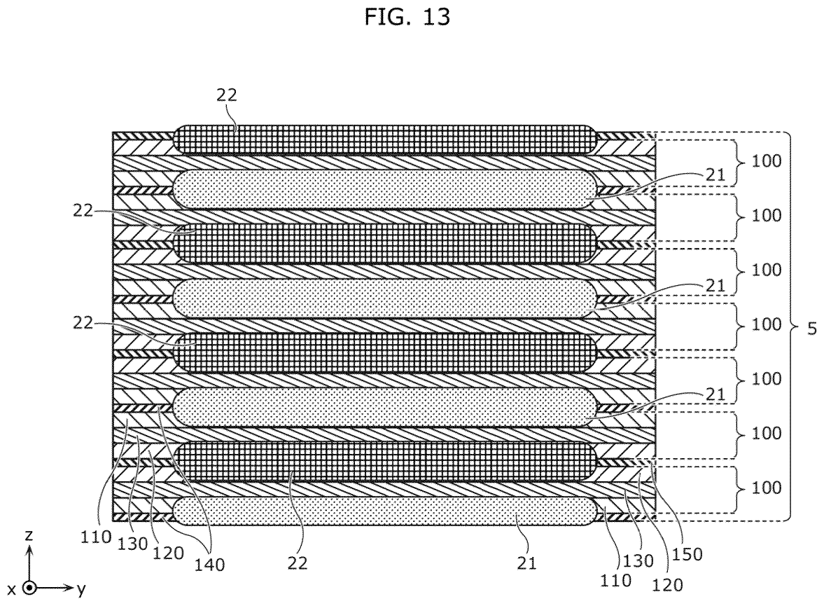

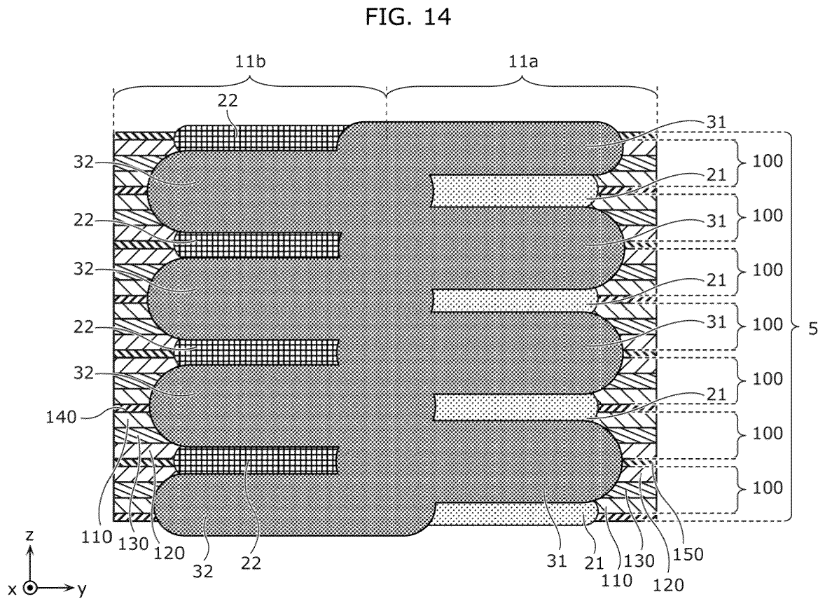

FIG. 11 is a cross-sectional view of battery 401 according to the present embodiment. FIG. 12 is another cross-sectional view of battery 401 according to the present embodiment. FIG. 13 is a plan view of power generating element 5 of battery 401 according to the present embodiment when viewed from the side (positive x-axis direction). FIG. 14 is another plan view of power generating element 5 of battery 401 according to the present embodiment when viewed from the side (positive x-axis direction). FIG. 15 is a side view of battery 401 according to the present embodiment. More specifically, FIG. 11 illustrates a cross section taken along line XI-XI illustrated in FIG. 15. FIG. 12 illustrates a cross section taken along line XII-XII illustrated in FIG. 15. FIG. 13 and FIG. 14 illustrate intermediate states in the manufacturing of battery 401. FIG. 13 is a view of battery 401 with counter electrode insulating layer 31, electrode insulating layer 32, electrode conductive extraction layer 41, and counter electrode conductive extraction layer 42 removed. FIG. 14 is a view of battery 401 with electrode conductive extraction layer 41 and counter electrode conductive extraction layer 42 removed. Battery 401 is manufactured, for example, by going through the states illustrated in FIG. 13 and FIG. 14 in this order. FIG. 15 is a plan view of battery 401 when viewed from the positive x-axis direction. FIG. 13 through FIG. 15 can also be said to be plan views of side surface 11.

Battery 401 according to the present embodiment differs from battery 1 according to Embodiment 1 in that electrode conductive connection portion 21, counter electrode conductive connection portion 22, counter electrode insulating layer 31, electrode insulating layer 32, electrode conductive extraction layer 41 and counter electrode conductive extraction layer 42 are all provided on side surface 11.

In battery 401, side surface 11 includes first region 11a and second region 11b that differs from first region 11a. First region 11a and second region 11b do not overlap with each other. First region 11a and second region 11b are positioned on the same plane (side surface 11) on the side surface of power generating element 5. First region 11a and second region 11b are, for example, aligned in the y-axis direction and are regions obtained by dividing side surface 11 into two parts along a line parallel to the stacking direction. In the example illustrated in FIG. 15, of the two divided regions, the region on the positive side in the y-axis direction is first region 11a, and the region on the negative side in the y-axis direction is second region 11b. The positions of first region 11a and second region 11b may be interchanged.

In battery 401, each of the plurality of electrode conductive connection portions 21 is connected to a different electrode current collector 140 in first region 11a. Each of the plurality of electrode conductive connection portions 21 is also provided in second region 11b and is connected to a different electrode current collector 140. This allows the connection area between electrode conductive connection portion 21 and electrode current collector 140 to be increased, thereby reducing the connection resistance between electrode current collector 140 and electrode conductive connection portion 21.

The plurality of electrode conductive connection portions 21 are respectively connected in contact with and cover the plurality of electrode current collectors 140 of power generating element 5 in first region 11a and second region 11b. Note that at least one of the plurality of electrode conductive connection portions 21 need not be provided in second region 11b. In battery 401, the plurality of electrode conductive connection portions 21 may be connected to electrode current collectors 140 on side surfaces other than side surface 11 of power generating element 5, and may be connected to electrode current collectors 140 across all side surfaces of power generating element 5.

In battery 401, each of the plurality of counter electrode conductive connection portions 22 is connected to a different counter electrode current collector 150 in second region 11b. Each of the plurality of counter electrode conductive connection portions 22 is also provided in first region 11a and is connected to a different counter electrode current collector 150. This allows the connection area between counter electrode conductive connection portion 22 and counter electrode current collector 150 to be increased, thereby reducing the connection resistance between counter electrode current collector 150 and counter electrode conductive connection portion 22.

The plurality of counter electrode conductive connection portions 22 are respectively connected in contact with and cover the plurality of counter electrode current collectors 150 of power generating element 5 in first region 11a and second region 11b. Note that at least one of the plurality of counter electrode conductive connection portions 22 need not be provided in first region 11a. In battery 401, the plurality of counter electrode conductive connection portions 22 may be connected to counter electrode current collectors 150 on side surfaces other than side surface 12 of power generating element 5, and may be connected to counter electrode current collectors 150 across all side surfaces of power generating element 5.

In the plan view of side surface 11 (first region 11a and second region 11b), electrode conductive connection portions 21 and counter electrode conductive connection portions 22 are alternately arranged along the stacking direction. In a view of battery 401 along the stacking direction of power generating element 5, electrode conductive connection portions 21 and counter electrode conductive connection portions 22 overlap.

In battery 401, in first region 11a, counter electrode insulating layer 31 covers at least a portion of counter electrode current collector 150 with counter electrode conductive connection portion 22 disposed therebetween. Counter electrode insulating layer 31 covers a portion of electrode conductive connection portion 21 in first region 11a. Counter electrode insulating layer 31 is positioned between first region 11a and electrode conductive extraction layer 41. In first region 11a, counter electrode insulating layer 31 contacts each of the plurality of counter electrode conductive connection portions 22, and covers each of the plurality of counter electrode conductive connection portions 22 and each of the plurality of counter electrode current collectors 150.

In battery 401, in second region 11b, electrode insulating layer 32 covers at least a portion of electrode current collector 140 with electrode conductive connection portion 21 disposed therebetween. Electrode insulating layer 32 covers a portion of counter electrode conductive connection portion 22 in second region 11b. Electrode insulating layer 32 is positioned between second region 11b and counter electrode conductive extraction layer 42. In second region 11b, electrode insulating layer 32 contacts each of the plurality of electrode conductive connection portions 21, and covers each of the plurality of electrode conductive connection portions 21 and each of the plurality of electrode current collectors 140.

Counter electrode insulating layer 31 and electrode insulating layer 32 are connected at the boundary of first region 11a and second region 11b, and are integrally formed. Therefore, at the boundary of first region 11a and second region 11b, counter electrode insulating layer 31 and electrode insulating layer 32 are integrated and cover almost the entire side surface 11 from the bottom to the top. Counter electrode insulating layer 31 and electrode insulating layer 32 are formed, for example, by coating them all at once, but may be formed by sequentially coating counter electrode insulating layer 31 and electrode insulating layer 32. Note that counter electrode insulating layer 31 and electrode insulating layer 32 may be formed separated. Each of counter electrode insulating layer 31 and electrode insulating layer 32 may be formed as plurality of individual units per corresponding counter electrode current collector 150 or electrode current collector 140.

In battery 401, electrode conductive extraction layer 41 covers a plurality of electrode conductive connection portions 21 and counter electrode insulating layer 31 in first region 11a, and is electrically connected to each of the plurality of electrode conductive connection portions 21. Electrode conductive extraction layer 41 and the plurality of counter electrode conductive connection portions 22 overlap in the plan view of first region 11a, and oppose each other with counter electrode insulating layer 31 disposed therebetween. This allows counter electrode conductive connection portion 22 to also be provided in first region 11a, and even when increasing the connection area between counter electrode conductive connection portion 22 and counter electrode current collector 150, short-circuiting due to contact between counter electrode conductive connection portion 22 and electrode conductive extraction layer 41 can be inhibited.

In battery 401, counter electrode conductive extraction layer 42 covers a plurality of counter electrode conductive connection portions 22 and electrode insulating layer 32 in second region 11b, and is electrically connected to each of the plurality of counter electrode conductive connection portions 22. Counter electrode conductive extraction layer 42 and the plurality of electrode conductive connection portions 21 overlap in the plan view of second region 11b, and oppose each other with electrode insulating layer 32 disposed therebetween. This allows electrode conductive connection portion 21 to also be provided in second region 11b, and even when increasing the connection area between electrode conductive connection portion 21 and electrode current collector 140, short-circuiting due to contact between electrode conductive connection portion 21 and counter electrode conductive extraction layer 42 can be inhibited.

Electrode conductive extraction layer 41 and counter electrode conductive extraction layer 42 are aligned in a direction (the y-axis direction) perpendicular to the stacking direction of power generating element 5 in the plan view of side surface 11 (first region 11a and second region 11b).

In the plan view of first region 11a, the length of each of the plurality of electrode conductive connection portions 21 in the direction (y-axis direction) perpendicular to the stacking direction of power generating element 5 is greater than the length of electrode conductive extraction layer 41 in the direction (y-axis direction) perpendicular to the stacking direction of power generating element 5.

In the plan view of second region 11b, the length of each of the plurality of counter electrode conductive connection portions 22 in the direction (y-axis direction) perpendicular to the stacking direction of power generating element 5 is greater than the length of counter electrode conductive extraction layer 42 in the direction (y-axis direction) perpendicular to the stacking direction of power generating element 5.

Note that battery 401, similar to battery 201, may include a plurality of at least one of electrode conductive extraction layer 41 or counter electrode conductive extraction layer 42. Moreover, in battery 401, similar to battery 301, at least one of the plurality of electrode conductive connection portions 21 or the plurality of counter electrode conductive connection portions 22 may be in the form of a broken line in the plan view of side surface 11.

In this way, in battery 401, first region 11a and second region 11b where the connection structure of battery cell 100 is formed are positioned on the same plane on a side surface of power generating element 5, specifically on side surface 11. This makes it possible to form both a plurality of electrode conductive connection portions 21 and a plurality of counter electrode conductive connection portions 22 on the same plane, enabling a compact region where the conductive connection portions are formed while also increasing the connection area between the current collector and the conductive connection portions, thereby reducing the connection resistance between the current collector and the conductive connection portions. Since both a plurality of electrode conductive connection portions 21 and a plurality of counter electrode conductive connection portions 22 are formed on the same plane, the manufacturing process for the plurality of electrode conductive connection portions 21 and the plurality of counter electrode conductive connection portions 22 can be simplified. More specifically, since a plurality of electrode conductive connection portions 21 and a plurality of counter electrode conductive connection portions 22 can be formed simultaneously in a single process, a high-performance battery 401 can be realized at low cost. Moreover, since electrode conductive extraction layer 41 and counter electrode conductive extraction layer 42 can also be formed on the same plane, the manufacturing process can be further simplified. Reducing the number of formation processes decreases the chance for damage or contamination to occur on the side surface portion of power generating element 5 during the formation processes, thereby improving the reliability of battery 401.

### Embodiment 5

Next, Embodiment 5 will be described. Hereinafter, the description will focus on the differences from Embodiments 1 to 4, while omitting or simplifying the description of common points.

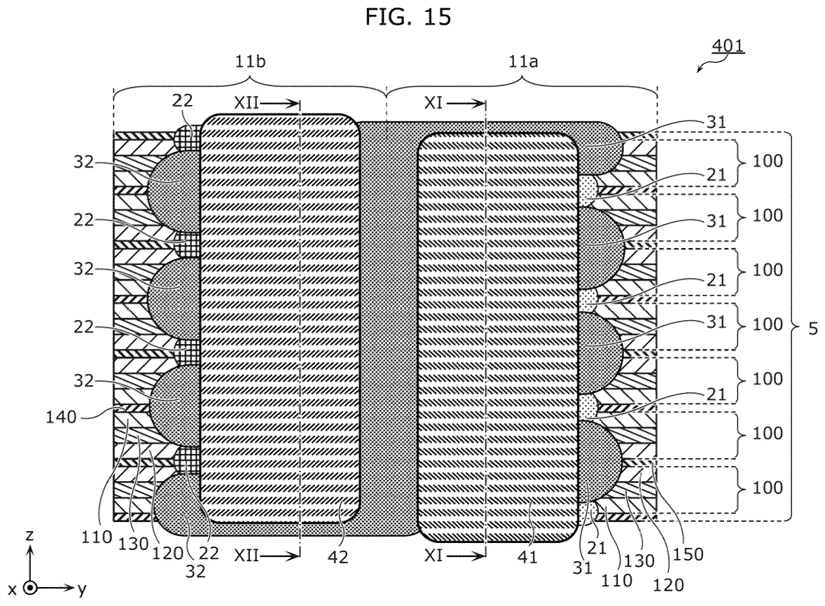

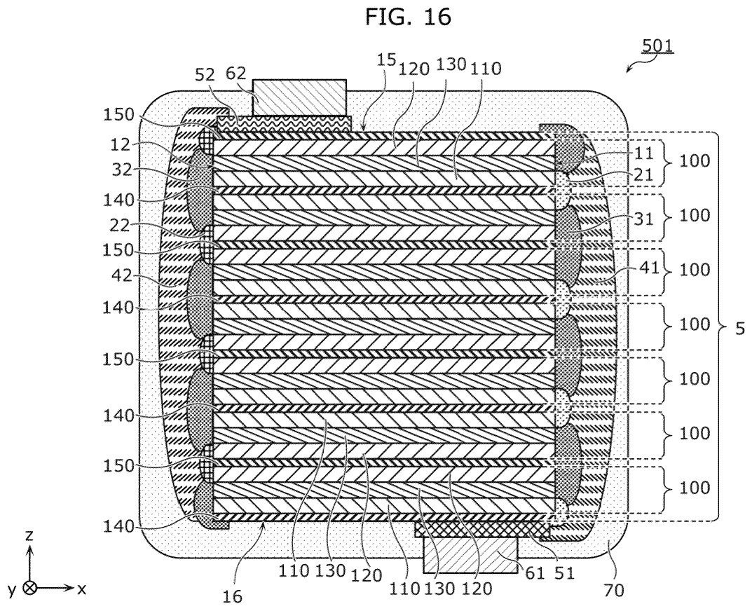

FIG. 16 is a cross-sectional view of battery 501 according to the present embodiment. As illustrated in FIG. 16, battery 501 according to the present embodiment differs from battery 1 according to Embodiment 1 in that it additionally includes electrode current collecting terminal 61, counter electrode current collecting terminal 62, and sealing component 70.

Sealing component 70 exposes at least a portion of electrode current collecting terminal 61 and at least a portion of counter electrode current collecting terminal 62, and seals power generating element 5. Sealing component 70 is provided, for example, so as not to expose power generating element 5, the plurality of electrode conductive connection portions 21, the plurality of counter electrode conductive connection portions 22, the plurality of counter electrode insulating layers 31, the plurality of electrode insulating layers 32, electrode conductive extraction layer 41, and counter electrode conductive extraction layer 42, and seals these. Stated differently, battery 501 has a configuration in which battery 1 is sealed by sealing component 70, and electrode current collecting terminal 61 and counter electrode current collecting terminal 62 are added as extraction terminals exposed from sealing component 70.

Sealing component 70 is formed using, for example, an electrically insulating material. Generally known materials for battery sealing components, such as sealants, for example, can be used as the insulating material. For example, a resin material can be used as the insulating material. The insulating material may be an insulating and non-ion-conductive material. For example, the insulating material may be at least one of epoxy resin, acrylic resin, polyimide resin, or silsesquioxane.

Sealing component 70 may include a plurality of different insulating materials. For example, sealing component 70 may have a multilayer structure. Each layer of the multilayer structure may be formed using a different material and have different properties.

Sealing component 70 may include particulate metal oxide material. Silicon oxide, aluminum oxide, titanium oxide, zinc oxide, cerium oxide, iron oxide, tungsten oxide, zirconium oxide, calcium oxide, zeolite, glass, etc., can be used as the metal oxide material. For example, sealing component 70 may be formed using a resin material in which a plurality of metal oxide material particles are dispersed.

The particle size of the metal oxide material may be less than or equal to the spacing between electrode current collector 140 and counter electrode current collector 150. The particle shape of the metal oxide material is, for example, but not limited to, spherical, ellipsoidal, or rod-shaped.

Sealing component 70 improves the reliability of battery 501 in various ways, including impact resistance, mechanical strength, short-circuit protection, and moisture proofing. For example, providing sealing component 70 improves the reliability of battery 501 against impacts such as collisions and drops during mounting, handling, or assembly of battery 501 or during use of battery 501.

Electrode current collecting terminal 61 is provided on electrode current collecting terminal 51, and is electrically connected to electrode conductive extraction layer 41 via electrode current collecting terminal 51. Electrode current collecting terminal 61 opposes main surface 16 with electrode current collecting terminal 51 disposed therebetween. Note that in battery 501, both electrode current collecting terminal 51 and electrode current collecting terminal 61 need not be provided on main surface 16, and only one of electrode current collecting terminal 51 or electrode current collecting terminal 61 may be provided on main surface 16 with a height from main surface 16 that is sufficient to be exposed from sealing component 70.

Counter electrode current collecting terminal 62 is provided on counter electrode current collecting terminal 52, and is electrically connected to counter electrode conductive extraction layer 42 via counter electrode current collecting terminal 52. Counter electrode current collecting terminal 62 opposes main surface 15 with counter electrode current collecting terminal 52 disposed therebetween. Note that in battery 501, both counter electrode current collecting terminal 52 and counter electrode current collecting terminal 62 need not be provided on main surface 15, and only one of counter electrode current collecting terminal 52 or counter electrode current collecting terminal 62 may be provided on main surface 15 with a height from main surface 15 that is sufficient to be exposed from sealing component 70.

Electrode current collecting terminal 61 and counter electrode current collecting terminal 62 are each formed using a material having conductivity. For example, electrode current collecting terminal 61 and counter electrode current collecting terminal 62 are metal foils or metal plates of, for example, copper, aluminum, or stainless steel. Alternatively, electrode current collecting terminal 61 and counter electrode current collecting terminal 62 may each be a conductive resin or cured solder. Electrode current collecting terminal 61 and counter electrode current collecting terminal 62 may be formed using the same material as electrode current collecting terminal 51 and counter electrode current collecting terminal 52, or may be formed using different materials.

Note that battery 501 includes a configuration in which battery 1 is sealed by sealing component 70, but this example is non-limiting. Battery 201, battery 301, or battery 401 may be sealed by sealing component 70.

Electrode conductive extraction layer 41 and counter electrode conductive extraction layer 42 may be exposed from sealing component 70. In this case, electrode current collecting terminal 51, counter electrode current collecting terminal 52, electrode current collecting terminal 61, and counter electrode current collecting terminal 62 need not be included in battery 501.

### Embodiment 6

Next, Embodiment 6 will be described. Hereinafter, the description will focus on the differences from Embodiments 1 to 5, while omitting or simplifying the description of common points.

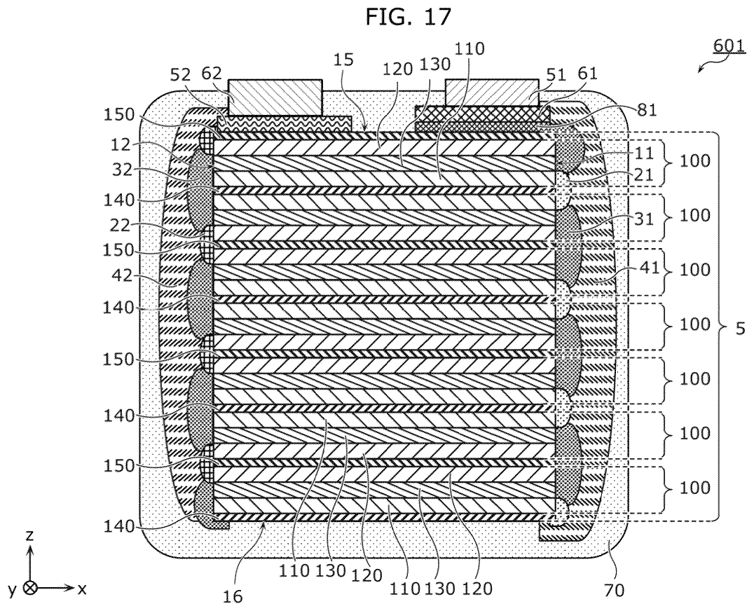

FIG. 17 is a cross-sectional view of battery 601 according to the present embodiment. As illustrated in FIG. 17, battery 601 according to the present embodiment differs from battery 501 according to Embodiment 5 in that electrode current collecting terminal 51, counter electrode current collecting terminal 52, electrode current collecting terminal 61, and counter electrode current collecting terminal 62 are all provided on main surface 15, and in that it additionally includes intermediate insulating layer 81.

In battery 601, electrode current collecting terminal 51 and electrode current collecting terminal 61 are arranged on main surface 15, above intermediate insulating layer 81.

In this way, in battery 601, electrode current collecting terminal 51, counter electrode current collecting terminal 52, electrode current collecting terminal 61, and counter electrode current collecting terminal 62 are provided on one of main surfaces, namely main surface 15, of power generating element 5. Since both the cathode and anode terminals are provided on the same main surface, battery 601 can be compactly mounted. For example, the pattern (also referred to as a footprint) of connection terminals formed on the mounting substrate can be reduced in size. Moreover, since this enables mounting with main surface 15 of power generating element 5 parallel to the mounting substrate, low-profile mounting with respect to the mounting substrate can be realized. Reflow solder connection and the like can be used for mounting. In this way, battery 601 with favorable mountability can be realized.

Electrode current collecting terminal 51, counter electrode current collecting terminal 52, electrode current collecting terminal 61, and counter electrode current collecting terminal 62 may be provided on main surface 16 of power generating element 5. In batteries 1, 201, 301, and 401 as well, both the counter electrode current collecting terminal and the electrode current collecting terminal may be provided on the same main surface of power generating element 5.

### Manufacturing Method

Next, the manufacturing method for a battery including power generating element 5 according to the above embodiments will be described.

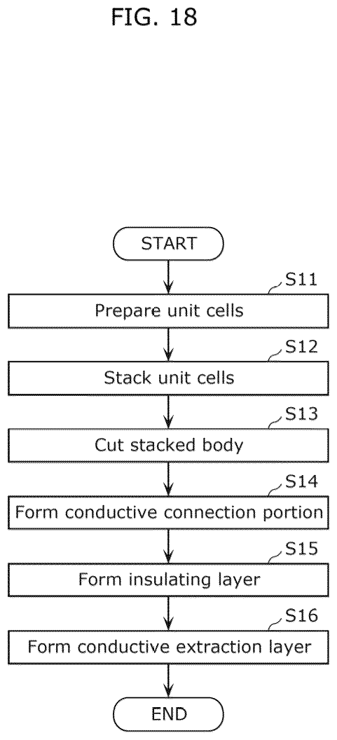

FIG. 18 is a flowchart illustrating one example of the manufacturing method of batteries according to each embodiment. The following description focuses on an example of the manufacturing method for battery 1 according to Embodiment 1. Each manufacturing method described below is merely one example. The manufacturing method of a battery according to the above embodiments is not limited to the following examples.

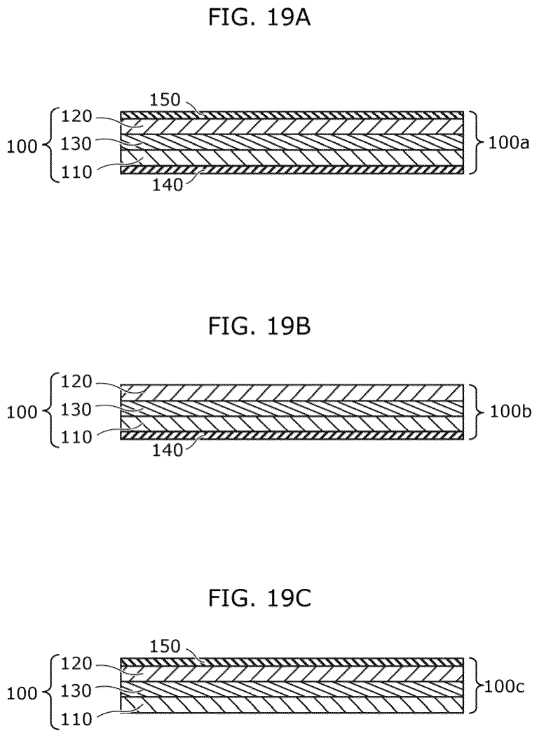

As illustrated in FIG. 18, first, a plurality of unit cells, each having a structure in which battery cell 100 and the current collector are stacked, are prepared (step S11). Next, a stacked body in which the plurality of unit cells are stacked is formed (step S12). The unit cell includes the above-described battery cell 100. Each of FIG. 19A through FIG. 19C is a cross-sectional view of one example of a unit cell.

As illustrated in FIG. 19A, unit cell 100a includes one battery cell 100, electrode current collector 140, and counter electrode current collector 150. In unit cell 100a, battery cell 100 is arranged between electrode current collector 140 and counter electrode current collector 150, and battery cell 100 is in contact with each of electrode current collector 140 and counter electrode current collector 150. More specifically, electrode layer 110 of battery cell 100 contacts electrode current collector 140, and counter electrode layer 120 of battery cell 100 contacts counter electrode current collector 150.

As illustrated in FIG. 19B, unit cell 100b includes one battery cell 100 and one electrode current collector 140. In unit cell 100b, electrode current collector 140 is arranged on the side, of battery cell 100, that is adjacent electrode layer 110, and is arranged opposing battery cell 100 and in contact with electrode layer 110. In battery cell 100 of unit cell 100b, the main surface, of counter electrode layer 120, that is on the side opposite the side adjacent solid electrolyte layer 130, is exposed.

As illustrated in FIG. 19C, unit cell 100c includes one battery cell 100 and one counter electrode current collector 150. In unit cell 100c, counter electrode current collector 150 is arranged on the side, of battery cell 100, that is adjacent counter electrode layer 120, and is arranged opposing battery cell 100 and in contact with counter electrode layer 120. In battery cell 100 of unit cell 100c, the main surface, of electrode layer 110, that is on the side opposite side adjacent solid electrolyte layer 130, is exposed.

For example, in step S11, at least one of the above-mentioned unit cells 100a, 100b, or 100c is prepared in accordance with the stacked configuration of the power generating elements included in the battery to be manufactured. For example, one unit cell 100a, a plurality of unit cells 100b, and a plurality of unit cells 100c are prepared. Unit cell 100a is arranged as the bottom-most layer, and unit cells 100b and 100c are stacked alternately toward the top. Here, unit cells 100b are stacked with a vertical orientation opposite the vertical orientation illustrated in FIG. 19B. This forms a stacked body with a stacked structure of power generating element 5 in which a plurality of battery cells 100 and a plurality of current collectors are stacked.

The method of forming a stacked body with a stacked structure of power generating element 5 is not limited to this example. For example, unit cell 100a may be arranged on the top-most layer. Alternatively, unit cell 100a may be arranged in a position other than the top-most or bottom-most layer. A plurality of unit cells 100a may be used. A unit of a unit cell with battery cell 100 stacked on the main surfaces on both sides of the current collector may be formed by double-sided coating on one current collector, and the formed unit may be stacked. The unit cell may be a unit cell that does not include a current collector and consists of battery cell 100.

Next, the stacked body formed in step S12 is cut (step S13). For example, by cutting the end portion of a stacked body of a plurality of unit cells in a batch in the stacking direction, power generating element 5 in which each side surface is a cut, flat surface can be formed. This allows for each layer to have the same area without being affected by variations in the area of each layer's coating. As a result, battery capacity variation is reduced and battery capacity accuracy is improved. The cutting process is performed, for example, by mechanical cutting using a blade, ultrasonic cutting using an ultrasonic cutter, laser cutting, or jet cutting. With these steps, power generating element 5 is prepared.

Step S13 may be omitted if the unit cell is formed in advance into a shape corresponding to the desired shape of power generating element 5. Instead of steps S11 to S13, power generating element 5 may be prepared by obtaining pre-formed power generating element 5.

Next, a conductive connection portion is formed on a side surface of power generating element 5 (step S14). More specifically, in side surface 11, electrode conductive connection portion 21 connected to electrode current collector 140 is formed. Here, for example, electrode conductive connection portion 21 including first inclined surface 21a so inclined with respect to side surface 11 that the length in the stacking direction of electrode conductive connection portion 21 decreases with increasing distance from side surface 11 is formed. In side surface 12, counter electrode conductive connection portion 22 connected to counter electrode current collector 150 is formed. Here, for example, counter electrode conductive connection portion 22 including second inclined surface 22a so inclined with respect to side surface 12 that the length in the stacking direction of counter electrode conductive connection portion 22 decreases with increasing distance from side surface 12 is formed.

The plurality of electrode conductive connection portions 21 and the plurality of counter electrode conductive connection portions 22 are formed, for example, by coating and curing a conductive paste such as a conductive resin. Coating is done by inkjet, spray, screen printing, or gravure printing. Curing is performed by drying, heating, or light irradiation, based on the conductive paste used.

When forming the plurality of electrode conductive connection portions 21 and the plurality of counter electrode conductive connection portions 22, a protective component may be formed by masking with tape or the like or by resist treatment in regions where no conductive connection portion should be formed. After forming the conductive connection portion, the protective component is removed.

In the case of manufacturing battery 301, in step S14, a plurality of electrode conductive connection portions 321 and a plurality of counter electrode conductive connection portions 322 are formed in the form of a broken line.

Next, an insulating layer is formed on a side surface of power generating element 5 (step S15). More specifically, in side surface 11 of power generating element 5, a plurality of counter electrode insulating layers 31 are formed that cover counter electrode current collector 150 and do not cover a portion of each of the plurality of electrode conductive connection portions 21. In side surface 12 of power generating element 5, a plurality of electrode insulating layers 32 are formed that cover electrode current collector 140 and do not cover a portion of each of the plurality of counter electrode conductive connection portions 22. Here, counter electrode insulating layer 31 is formed to cover a portion of electrode conductive connection portion 21, and electrode insulating layer 32 is formed to cover a portion of counter electrode conductive connection portion 22. In this way, by forming counter electrode insulating layer 31 and electrode insulating layer 32 after the formation of electrode conductive connection portion 21 and counter electrode conductive connection portion 22, a structure in which counter electrode insulating layer 31 covers a portion of electrode conductive connection portion 21 and electrode insulating layer 32 covers a portion of counter electrode conductive connection portion 22 can be easily formed. Counter electrode insulating layer 31 is formed to cover first inclined surface 21a, and electrode insulating layer 32 is formed to cover second inclined surface 22a.

Counter electrode insulating layer 31 and electrode insulating layer 32 are formed, for example, by coating and curing a liquid resin material. Coating is done by inkjet, spray, screen printing, or gravure printing. Curing is performed by drying, heating, or light irradiation, based on the resin material used.

Note that at least one of a portion of counter electrode insulating layer 31 or a portion of electrode insulating layer 32 may be formed before step S14. In such cases, a portion of counter electrode insulating layer 31 is a portion that does not cover electrode conductive connection portion 21, and a portion of electrode insulating layer 32 is a portion that does not cover counter electrode conductive connection portion 22.

Next, a conductive extraction layer is formed on a side surface of power generating element 5 (step S16). More specifically, in side surface 11 of power generating element 5, electrode conductive extraction layer 41 is formed to cover a plurality of electrode conductive connection portions 21 and a plurality of counter electrode insulating layers 31, and is electrically connected to the plurality of electrode conductive connection portions 21. In side surface 12 of power generating element 5, counter electrode conductive extraction layer 42 is formed to cover a plurality of counter electrode conductive connection portions 22 and a plurality of electrode insulating layers 32, and is electrically connected to the plurality of counter electrode conductive connection portions 22. In step S16, when manufacturing battery 201, a plurality of electrode conductive extraction layers 41 are formed to be aligned in the direction perpendicular to the stacking direction of power generating element 5 in the plan view of side surface 11, and a plurality of counter electrode conductive extraction layers 42 are formed to be aligned in the direction perpendicular to the stacking direction of power generating element 5 in the plan view of side surface 12.

For example, electrode conductive extraction layer 41 is formed by coating and curing a conductive paste such as a conductive resin to cover, on side surface 11 of power generating element 5: the portions of the plurality of electrode conductive connection portions 21 not covered by the plurality of counter electrode insulating layers 31; and the plurality of counter electrode insulating layers 31. This electrically connects electrode conductive extraction layer 41 to each of the plurality of electrode conductive connection portions 21. Counter electrode conductive extraction layer 42 is formed by coating and curing a conductive paste such as a conductive resin to cover, on side surface 12 of power generating element 5: the portions of the plurality of counter electrode conductive connection portions 22 not covered by the plurality of electrode insulating layers 32; and the plurality of electrode insulating layers 32. This electrically connects counter electrode conductive extraction layer 42 to each of the plurality of counter electrode conductive connection portions 22. Forming counter electrode insulating layer 31 and electrode insulating layer 32 before the formation of electrode conductive extraction layer 41 and counter electrode conductive extraction layer 42 inhibits the occurrence of short circuits. Electrode conductive extraction layer 41 and counter electrode conductive extraction layer 42 may be formed by printing, plating, vapor deposition, sputtering, welding, soldering, bonding, or some other method.

After this, counter electrode current collecting terminal 52 to be electrically connected to counter electrode conductive extraction layer 42 is formed on main surface 15 of power generating element 5 on which a conductive connection portion, an insulating layer, and a conductive extraction layer have been formed. Electrode current collecting terminal 51 to be electrically connected to electrode conductive extraction layer 41 is formed on main surface 16 of power generating element 5. With this, battery 1 is manufactured. Electrode current collecting terminal 51 and counter electrode current collecting terminal 52 are formed by placing a conductive material such as a metal material in a desired region by plating, printing, or soldering. The formation of electrode current collecting terminal 51 and counter electrode current collecting terminal 52 may be performed at any timing after step S11.

In addition, if necessary, electrode current collecting terminal 61, counter electrode current collecting terminal 62, and sealing component 70 may be formed on obtained battery 1. Sealing component 70 is formed, for example, by coating and curing a liquid resin material. Coating is done by inkjet, spray, screen printing, or gravure printing. Curing is performed by drying, heating, or light irradiation, based on the resin material used.

The process of pressing the plurality of unit cells prepared in step S11 in the stacking direction may be performed individually or after stacking the plurality of unit cells.

When manufacturing battery 401, steps S14 to S16 are performed on side surface 11.

### OTHER EMBODIMENTS

Although a battery and a battery manufacturing method according to one or more aspects of the present disclosure have been described based on embodiments, the present disclosure is not limited to these embodiments. Various modifications of the embodiments as well as embodiments resulting from arbitrary combinations of elements of different embodiments that may be conceived by those skilled in the art are included within the scope of the present disclosure as long as these do not depart from the essence of the present disclosure.

For example, in what relationship the plurality of battery cells 100 in power generating element 5 are connected is not limited to the examples described in the above embodiments. For example, at least some of the plurality of battery cells 100 may be connected in parallel, and may be connected in any combination of series and parallel connections. Power generating element 5 may include a configuration in which groups of battery cells 100 connected in parallel by conductive connection portions and conductive extraction layers on the side surface are further connected in series. Power generating element 5 may further connect groups of battery cells 100 connected in series in parallel using conductive connection portions and conductive extraction layers on the side surface. Battery cells 100 connected in series may be connected on the main surface side where battery cells 100 are stacked.

For example, in the above embodiment, the four side surfaces of power generating element 5 are flat surfaces, but the present disclosure is not limited to this example. At least one layer or current collector of battery cell 100 may protrude or be recessed on the side surface of power generating element 5.

For example, in the above embodiment, the battery included a counter electrode conductive connection portion and a counter electrode conductive extraction layer, but the present disclosure is not limited to this example. In the battery, the extraction electrode of the counter electrode layer may be realized by a configuration other than the counter electrode conductive connection portion and counter electrode conductive extraction layer.

Changes, substitutions, additions, and deletions may be made in the above embodiments in various ways within the scope of the claims or their equivalents.

### INDUSTRIAL APPLICABILITY

The battery according to the present disclosure is applicable, for example, as a battery for electronic devices, electrical equipment, and electric vehicles.

1. A battery comprising:
a power generating element including a plurality of battery cells and a plurality of current collectors, the plurality of battery cells and the plurality of current collectors being stacked with at least a portion of the plurality of battery cells electrically connected in parallel, each of the plurality of battery cells including an electrode layer, a counter electrode layer, and a solid electrolyte layer positioned between the electrode layer and the counter electrode layer;
an electrode conductive connection portion; and
a counter electrode insulating layer, wherein
each of the plurality of battery cells is sandwiched between two adjacent current collectors among the plurality of current collectors,
the plurality of current collectors include an electrode current collector electrically connected to the electrode layer of a battery cell among the plurality of battery cells and a counter electrode current collector electrically connected to the counter electrode layer of a battery cell among the plurality of battery cells,
the electrode conductive connection portion is connected to the electrode current collector in a first region of a side surface of the power generating element, and
in the first region, the counter electrode insulating layer covers a portion of the electrode conductive connection portion and at least a portion of the counter electrode current collector.

2. The battery according to claim 1, further comprising:
an electrode conductive extraction layer covering at least a portion of the counter electrode insulating layer in the first region and electrically connected to the electrode conductive connection portion.

3. The battery according to claim 2, wherein
the electrode conductive connection portion comprises a plurality of electrode conductive connection portions,
in the first region, the plurality of electrode conductive connection portions are respectively connected to different electrode current collectors each of which is the electrode current collector, and
the electrode conductive extraction layer is electrically connected to each of the plurality of electrode conductive connection portions in the first region.

4. The battery according to claim 3, wherein
the plurality of electrode conductive connection portions have a stripe shape in a plan view of the first region.

5. The battery according to claim 3, wherein
the electrode conductive extraction layer comprises a plurality of electrode conductive extraction layers, and
in a plan view of the first region, the plurality of electrode conductive extraction layers are aligned in a direction perpendicular to a stacking direction of the power generating element.

6. The battery according to claim 2, further comprising:
a void surrounded by an inner wall formed by at least one selected from the group consisting of the first region, the electrode conductive connection portion, the counter electrode insulating layer, and the electrode conductive extraction layer.

7. The battery according to claim 1, wherein
the electrode conductive connection portion includes a first inclined surface so inclined with respect to the first region that a length in a stacking direction of the electrode conductive connection portion decreases with increasing distance from the first region of the power generating element, and
the counter electrode insulating layer covers the first inclined surface.

8. The battery according to claim 1, further comprising:
a counter electrode conductive connection portion connected to the counter electrode current collector in a second region of the side surface of the power generating element different from the first region; and
an electrode insulating layer covering a portion of the counter electrode conductive connection portion and at least a portion of the electrode current collector in the second region.

9. The battery according to claim 8, further comprising:
a counter electrode conductive extraction layer covering at least a portion of the electrode insulating layer in the second region and electrically connected to the counter electrode conductive connection portion.

10. The battery according to claim 9, wherein
the counter electrode conductive extraction layer comprises a plurality of counter electrode conductive extraction layers, and
in a plan view of the first region, the plurality of counter electrode conductive extraction layers are aligned in a direction perpendicular to a stacking direction of the power generating element.

11. The battery according to claim 9, further comprising:
an electrode conductive extraction layer covering at least a portion of the counter electrode insulating layer in the first region and electrically connected to the electrode conductive connection portion;
an electrode current collecting terminal provided on one main surface of the power generating element and electrically connected to the electrode conductive extraction layer; and
a counter electrode current collecting terminal provided on an other main surface of the power generating element and electrically connected to the counter electrode conductive extraction layer.

12. The battery according to claim 9, further comprising:
an electrode conductive extraction layer covering at least a portion of the counter electrode insulating layer in the first region and electrically connected to the electrode conductive connection portion;
an electrode current collecting terminal provided on one main surface of the power generating element and electrically connected to the electrode conductive extraction layer; and
a counter electrode current collecting terminal provided on the one main surface and electrically connected to the counter electrode conductive extraction layer.

13. The battery according to claim 11, further comprising:
a sealing component that exposes a portion of the electrode current collecting terminal and a portion of the counter electrode current collecting terminal, and seals the power generating element, the electrode conductive connection portion, the electrode conductive extraction layer, the counter electrode conductive connection portion, and the counter electrode conductive extraction layer.

14. The battery according to claim 8, wherein
the counter electrode conductive connection portion includes a second inclined surface so inclined with respect to the second region that a length in a stacking direction of the counter electrode conductive connection portion decreases with increasing distance from the second region of the power generating element, and
the electrode insulating layer covers the second inclined surface.

15. The battery according to claim 8, wherein
the first region and the second region are positioned on a same plane on the side surface of the power generating element.

16. The battery according to claim 15, wherein
the electrode conductive connection portion is connected to the electrode current collector in the first region and the second region, and
the counter electrode conductive connection portion is connected to the counter electrode current collector in the first region and the second region.

17. The battery according to claim 1, wherein
the counter electrode insulating layer includes resin.

18. The battery according to claim 1, wherein
the electrode conductive connection portion is in a form of a broken line in a plan view of the first region.
